(19) United States
(12) Patent Application Publication
(10) Pub. No.: US 2026/0116428 A1
(43) Pub. Date: Apr. 30, 2026

(54) KNOWLEDGE DISTILLATION TECHNIQUES

(71) Applicant: Mobileye Vision Technologies Ltd., Jerusalem (IL)

(72) Inventors: Eran Malach, Jerusalem (IL); Gal Kaplun, Jerusalem (IL); Shai Shalev-Shwartz, Jerusalem (IL)

(73) Assignee: Mobileye Vision Technologies Ltd., Jerusalem (IL)

(21) Appl. No.: 18/835,584

(22) PCT Filed: Feb. 7, 2023
(86) PCT No.: PCT/IB2023/051087

§ 371 Date: Aug. 2, 2024

Related U.S. Application Data
(60) Provisional application No. 63/307,833, filed on Feb. 8, 2022.
(60) Provisional application No. 63/322,013, filed on Mar. 21, 2022.

(51) Int. Cl. B60W 60/00; G05B 13/02

(52) U.S. Cl. CPC B60W 60/0015; G05B 13/0265; B60W 2554/00

(57) ABSTRACT

Techniques are disclosed for performing knowledge distillation in the context of machine learning model training. A fixed pool of “teacher” models are provided, which meet predefined conditions. A machine learning model is then trained to provide a “student.” by applying a random selection of the teachers to unlabeled sample data, which accelerates the training process. The algorithm implemented for this purpose ensures that the trained student provides low error.

### CROSS-REFERENCE TO RELATED APPLICATIONS

This application claims the benefit of and priority to U.S. provisional application No. 63/307,833, filed Feb. 8, 2022, and U.S. provisional application No. 63/322,013, filed Mar. 21, 2022, the contents of each of which are incorporated herein by reference in their entireties.

### TECHNICAL FIELD

Aspects described herein generally relate to knowledge distillation techniques and, more particularly, to the use of knowledge distillation techniques for training models in the context of machine learning.

### BACKGROUND

Recently, the field of supervised learning has witnessed the success of overparameterized methods: models, like deep neural networks, which are large enough to fit their training set but still achieve good test performance. A core theoretical concern is to understand why such models are able to fit even noisy training data without catastrophically overfitting despite no explicit regularization [31]. The seminal work of Bartlett [2] proposed the theoretical framework of benign overfitting to capture this empirical behavior. Briefly, benign overfitting studies statistically consistent methods—where models approach the Bayes optimal function, even in the presence of noise.

However, recent empirical work shows that when training deep neural networks on noisy data, overfitting is neither catastrophic nor benign [20]. Specifically, conventionally it has been proposed that overfitting leads not to a good classifier, but to a good conditional sampler. For example, suppose a model is trained on a set of images sampled from some distribution D, where 20% of the images of cats are wrongly labeled as dogs. We now train an overparameterized network to fit samples from [symbol] . Note that for the distribution [symbol] , the Bayes-optimal classifier, namely

$${f}_{𝒟}^{*} ( x ) := arg {max}_{y} {ℙ}_{𝒟} ( y \vert x )$$

returns the “correct” class of every image. Thus, if overfitting is truly “benign” in the sense of [2], the overparameterized model will be close to this optimal

$${f}_{𝒟}^{*} .$$

However, this is not what occurs in practice (See [20]); the trained model ƒ reproduces noise in the training set at test time, labeling up to 20% of the cats in the test data as dogs. In a sense, the trained model ƒ behaves as a conditional sampler: ƒ(x)˜ [symbol] (y|x) (see the confusion matrix in FIG. 3A).

The above example indicates that thinking about classifiers in the overparameterized regime as approximating the Bayes optimal predictor might be misleading. Therefore, it is essential to develop the appropriate theoretical framework for describing the behavior of samplers from the conditional distribution. While the learning-theoretical aspects of supervised classification are well-studied, the theory of supervised conditional sampling has not been systematically explored. The embodiments described herein aim to address this gap. A study of conditional sampling is provided as a learning problem, and its relations to other kinds of learning are then explored.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIG. 1 illustrates an exemplary vehicle in accordance with one or more aspects of the present disclosure.

FIG. 2 illustrates various exemplary electronic components of a safety system of a vehicle in accordance with one or more aspects of the present disclosure.

FIG. 3A illustrates an example confusion matrix showing how a trained model ƒ behaves as a conditional sampler, in accordance with one or more aspects of the present disclosure.

FIG. 3B illustrates an example confusion matrix corresponding to the execution of an ensemble of samplers at inference time, in accordance with one or more aspects of the present disclosure.

FIG. 3C illustrates an example confusion matrix corresponding to the implementation of a distillation algorithm in which each sample is labeled by a random teacher from a predetermined set of teachers, in accordance with one or more aspects of the present disclosure.

FIG. 4 illustrates a chart indicating test accuracy versus the number of teachers used, in accordance with one or more aspects of the present disclosure.

FIG. 5 illustrates an example model training architecture, in accordance with one or more aspects of the present disclosure.

FIG. 6 illustrates an example process flow, in accordance with one or more aspects of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

### A. An Example Vehicle

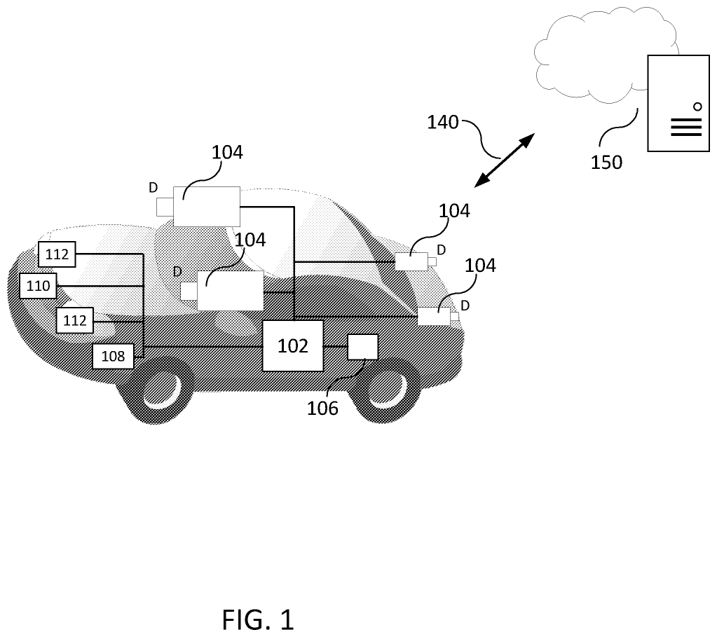

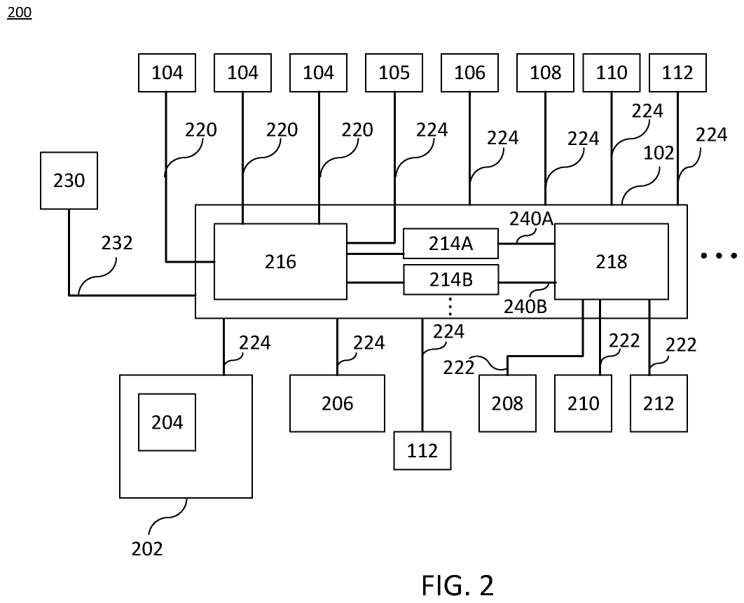

FIG. 1 illustrates a vehicle 100 including a safety system 200 (see also FIG. 2) in accordance with various aspects of the present disclosure. The vehicle 100 and the safety system 200 are exemplary in nature, and may thus be simplified for explanatory purposes. Locations of elements and relational distances (as discussed herein, the Figures are not to scale) are provided by way of example and not limitation. The safety system 200 may include various components depending on the requirements of a particular implementation and/or application, and may facilitate the navigation and/or control of the vehicle 100. The vehicle 100 may be an autonomous vehicle (AV), which may include any level of automation (e.g. levels 0-5), which includes no automation or full automation (level 5). The vehicle 100 may implement the safety system 200 as part of any suitable type of autonomous or driving assistance control system, including AV and/or an advanced driver-assistance system (ADAS), for instance. The safety system 200 may include one or more components that are integrated as part of the vehicle 100 during manufacture, part of an add-on or aftermarket device, or combinations of these. Thus, the various components of the safety system 200 as shown in FIG. 2 may be integrated as part of the vehicle 100's systems and/or part of an aftermarket system that is installed in the vehicle 100.

The one or more processors 102 may be integrated with or separate from an electronic control unit (ECU) of the vehicle 100 or an engine control unit of the vehicle 100, which may be considered herein as a specialized type of an electronic control unit. The safety system 200 may generate data to control or assist to control the ECU and/or other components of the vehicle 100 to directly or indirectly control the driving of the vehicle 100. However, the aspects described herein are not limited to implementations within autonomous or semi-autonomous vehicles, as these are provided by way of example. The aspects described herein may be implemented as part of any suitable type of vehicle that may be capable of travelling with or without any suitable level of human assistance in a particular driving environment. Therefore, one or more of the various vehicle components such as those discussed herein with reference to FIG. 2 for instance, may be implemented as part of a standard vehicle (i.e. a vehicle not using autonomous driving functions), a fully autonomous vehicle, and/or a semi-autonomous vehicle, in various aspects. In aspects implemented as part of a standard vehicle, it is understood that the safety system 200 may perform alternate functions, and thus in accordance with such aspects the safety system 200 may alternatively represent any suitable type of system that may be implemented by a standard vehicle without necessarily utilizing autonomous or semi-autonomous control related functions.

Regardless of the particular implementation of the vehicle 100 and the accompanying safety system 200 as shown in FIG. 1 and FIG. 2, the safety system 200 may include one or more processors 102, one or more image acquisition devices 104 such as, e.g., one or more vehicle cameras or any other suitable sensor configured to perform image acquisition over any suitable range of wavelengths, one or more position sensors 106, which may be implemented as a position and/or location-identifying system such as a Global Navigation Satellite System (GNSS), e.g., a Global Positioning System (GPS), one or more memories 202, one or more map databases 204, one or more user interfaces 206 (such as, e.g., a display, a touch screen, a microphone, a loudspeaker, one or more buttons and/or switches, and the like), and one or more wireless transceivers 208, 210, 212. Additionally or alternatively, the one or more user interfaces 206 may be identified with other components in communication with the safety system 200, such as one or more components of an ADAS system, an AV system, etc., as further discussed herein.

The wireless transceivers 208, 210, 212 may be configured to operate in accordance with any suitable number and/or type of desired radio communication protocols or standards. By way of example, a wireless transceiver (e.g., a first wireless transceiver 208) may be configured in accordance with a Short-Range mobile radio communication standard such as e.g. Bluetooth, Zigbee, and the like. As another example, a wireless transceiver (e.g., a second wireless transceiver 210) may be configured in accordance with a Medium or Wide Range mobile radio communication standard such as e.g. a 3G (e.g. Universal Mobile Telecommunications System—UMTS), a 4G (e.g. Long Term Evolution-LTE), or a 5G mobile radio communication standard in accordance with corresponding 3GPP (3rd Generation Partnership Project) standards, the most recent version at the time of this writing being the 3GPP Release 16 (2020).

As a further example, a wireless transceiver (e.g., a third wireless transceiver 212) may be configured in accordance with a Wireless Local Area Network communication protocol or standard such as e.g. in accordance with IEEE 802.11 Working Group Standards, the most recent version at the time of this writing being IEEE Std 802.11™-2020, published Feb. 26, 2021 (e.g. 802.11, 802.11a, 802.11b, 802.11 g, 802.11n, 802.11p, 802.11-12, 802.11ac, 802.1 lad, 802.11ah, 802.11ax, 802.11ay, and the like). The one or more wireless transceivers 208, 210, 212 may be configured to transmit signals via an antenna system (not shown) using an air interface. As additional examples, one or more of the transceivers 208, 210, 212 may be configured to implement one or more vehicle to everything (V2X) communication protocols, which may include vehicle to vehicle (V2V), vehicle to infrastructure (V2I), vehicle to network (V2N), vehicle to pedestrian (V2P), vehicle to device (V2D), vehicle to grid (V2G), and any other suitable communication protocols.

One or more of the wireless transceivers 208, 210, 212 may additionally or alternatively be configured to enable communications between the vehicle 100 and one or more other remote computing devices 150 via one or more wireless links 140. This may include, for instance, communications with a remote server or other suitable computing system as shown in FIG. 1. The example shown FIG. 1 illustrates such a remote computing system 150 as a cloud computing system, although this is by way of example and not limitation, and the computing system 150 may be implemented in accordance with any suitable architecture and/or network and may constitute one or several physical computers, servers, processors, etc. that comprise such a system. As another example, the remote computing system 150 may be implemented as an edge computing system and/or network.

The one or more processors 102 may implement any suitable type of processing circuitry, other suitable circuitry, memory, etc., and utilize any suitable type of architecture. The one or more processors 102 may be configured as a controller implemented by the vehicle 100 to perform various vehicle control functions, navigational functions, etc. For example, the one or more processors 102 may be configured to function as a controller for the vehicle 100 to analyze sensor data and received communications, to calculate specific actions for the vehicle 100 to execute for navigation and/or control of the vehicle 100, and to cause the corresponding action to be executed, which may be in accordance with an AV or ADAS system, for instance. The one or more processors 102 and/or the safety system 200 may form the entirety of or portion of an advanced driver-assistance system (ADAS) or an autonomous vehicle (AV) system.

Moreover, one or more of the processors 214A, 214B, 216, and/or 218 of the one or more processors 102 may be configured to work in cooperation with one another and/or with other components of the vehicle 100 to collect information about the environment (e.g., sensor data, such as images, depth information (for a Lidar for example), etc.). In this context, one or more of the processors 214A, 214B, 216, and/or 218 of the one or more processors 102 may be referred to as “processors.” The processors may thus be implemented (independently or together) to create mapping information from the harvested data, e.g., Road Segment Data (RSD) information that may be used for Road Experience Management (REM) mapping technology, the details of which are further described below. As another example, the processors can be implemented to process mapping information (e.g. roadbook information used for REM mapping technology) received from remote servers over a wireless communication link (e.g. link 140) to localize the vehicle 100 on an AV map, which can be used by the processors to control the vehicle 100.

The one or more processors 102 may include one or more application processors 214A, 214B, an image processor 216, a communication processor 218, and may additionally or alternatively include any other suitable processing device, circuitry, components, etc. not shown in the Figures for purposes of brevity. Similarly, image acquisition devices 104 may include any suitable number of image acquisition devices and components depending on the requirements of a particular application. Image acquisition devices 104 may include one or more image capture devices (e.g., cameras, charge coupling devices (CCDs), or any other type of image sensor). The safety system 200 may also include a data interface communicatively connecting the one or more processors 102 to the one or more image acquisition devices 104. For example, a first data interface may include any wired and/or wireless first link 220, or first links 220 for transmitting image data acquired by the one or more image acquisition devices 104 to the one or more processors 102, e.g., to the image processor 216.

The wireless transceivers 208, 210, 212 may be coupled to the one or more processors 102, e.g., to the communication processor 218, e.g., via a second data interface. The second data interface may include any wired and/or wireless second link 222 or second links 222 for transmitting radio transmitted data acquired by wireless transceivers 208, 210, 212 to the one or more processors 102, e.g., to the communication processor 218. Such transmissions may also include communications (one-way or two-way) between the vehicle 100 and one or more other (target) vehicles in an environment of the vehicle 100 (e.g., to facilitate coordination of navigation of the vehicle 100 in view of or together with other (target) vehicles in the environment of the vehicle 100), or even a broadcast transmission to unspecified recipients in a vicinity of the transmitting vehicle 100.

The memories 202, as well as the one or more user interfaces 206, may be coupled to each of the one or more processors 102, e.g., via a third data interface. The third data interface may include any suitable wired and/or wireless third link 224 or third links 224. Furthermore, the position sensors 106 may be coupled to each of the one or more processors 102, e.g., via the third data interface.

Each processor 214A, 214B, 216, 218 of the one or more processors 102 may be implemented as any suitable number and/or type of hardware-based processing devices (e.g. processing circuitry), and may collectively, i.e. with the one or more processors 102 form one or more types of controllers as discussed herein. The architecture shown in FIG. 2 is provided for ease of explanation and as an example, and the vehicle 100 may include any suitable number of the one or more processors 102, each of which may be similarly configured to utilize data received via the various interfaces and to perform one or more specific tasks.

For example, the one or more processors 102 may form a controller that is configured to perform various control-related functions of the vehicle 100 such as the calculation and execution of a specific vehicle following speed, velocity, acceleration, braking, steering, trajectory, etc. As another example, the vehicle 100 may, in addition to or as an alternative to the one or more processors 102, implement other processors (not shown) that may form a different type of controller that is configured to perform additional or alternative types of control-related functions. Each controller may be responsible for controlling specific subsystems and/or controls associated with the vehicle 100. In accordance with such aspects, each controller may receive data from respectively coupled components as shown in FIG. 2 via respective interfaces (e.g. 220, 222, 224, 232, etc.), with the wireless transceivers 208, 210, and/or 212 providing data to the respective controller via the second links 222, which function as communication interfaces between the respective wireless transceivers 208, 210, and/or 212 and each respective controller in this example.

To provide another example, the application processors 214A, 214B may individually represent respective controllers that work in conjunction with the one or more processors 102 to perform specific control-related tasks. For instance, the application processor 214A may be implemented as a first controller, whereas the application processor 214B may be implemented as a second and different type of controller that is configured to perform other types of tasks as discussed further herein. In accordance with such aspects, the one or more processors 102 may receive data from respectively coupled components as shown in FIG. 2 via the various interfaces 220, 222, 224, 232, etc., and the communication processor 218 may provide communication data received from other vehicles (or to be transmitted to other vehicles) to each controller via the respectively coupled links 240A, 240B, which function as communication interfaces between the respective application processors 214A, 214B and the communication processors 218 in this example. Of course, the application processors 214A, 214B may perform other functions in addition to or as an alternative to control-based functions, such as the various processing functions discussed herein, providing warnings regarding possible collisions, etc.

The one or more processors 102 may additionally be implemented to communicate with any other suitable components of the vehicle 100 to determine a state of the vehicle while driving or at any other suitable time, which may comprise an analysis of data representative of a vehicle status. For instance, the vehicle 100 may include one or more vehicle computers, sensors, ECUs, interfaces, etc., which may collectively be referred to as vehicle components 230 as shown in FIG. 2. The one or more processors 102 are configured to communicate with the vehicle components 230 via an additional data interface 232, which may represent any suitable type of links and operate in accordance with any suitable communication protocol (e.g. CAN bus communications). Using the data received via the data interface 232, the one or more processors 102 may determine any suitable type of vehicle status information such as the current drive gear, current engine speed, acceleration capabilities of the vehicle 100, etc. As another example, various metrics used to control the speed, acceleration, braking, steering, etc. may be received via the vehicle components 230, which may include receiving any suitable type of signals that are indicative of such metrics or varying degrees of how such metrics vary over time (e.g. brake force, wheel angle, reverse gear, etc.).

The one or more processors 102 may include any suitable number of other processors 214A, 214B, 216, 218, each of which may comprise processing circuitry such as sub-processors, a microprocessor, pre-processors (such as an image pre-processor), graphics processors, a central processing unit (CPU), support circuits, digital signal processors, integrated circuits, memory, or any other types of devices suitable for running applications and for data processing (e.g. image processing, audio processing, etc.) and analysis and/or to enable vehicle control to be functionally realized. In some aspects, each processor 214A, 214B, 216, 218 may include any suitable type of single or multi-core processor, microcontroller, central processing unit, etc. These processor types may each include multiple processing units with local memory and instruction sets. Such processors may include video inputs for receiving image data from multiple image sensors, and may also include video out capabilities.

Any of the processors 214A, 214B, 216, 218 disclosed herein may be configured to perform certain functions in accordance with program instructions, which may be stored in the local memory of each respective 214A, 214B, 216, 218 or accessed via another memory that is part of the safety system 200 or external to the safety system 200. This memory may include the one or more memories 202. Regardless of the particular type and location of memory accessed by the 214A, 214B, 216, 218, the memory may store software and/or executable instructions that, when executed by a relevant processor (e.g., by the one or more processors 102, one or more of the processors 214A, 214B, 216, 218, etc.), controls the operation of the safety system 200 and may perform other functions such as identifying the location of the vehicle 100 (e.g. via the one or more position sensors 106), determining the location of one or more hotspots, determining a SDM rule, adjusting SDM parameters in accordance with SDM rules, and/or when to cause the user interface to issue appropriate warnings, which may include the use of the interface 206 or any other suitable display device for this purpose, as further discussed herein.

A relevant memory accessed by the one or more processors 214A, 214B, 216, 218 (e.g. the one or more memories 202) may also store one or more databases and image processing software, as well as a trained system, such as a neural network, or a deep neural network, for example, that may be utilized to perform the tasks in accordance with any of the aspects as discussed herein. A relevant memory accessed by the one or more processors 214A, 214B, 216, 218 (e.g. the one or more memories 202) may be implemented as any suitable number and/or type of non-transitory computer-readable medium such as random-access memories, read only memories, flash memories, disk drives, optical storage, tape storage, removable storage, or any other suitable types of storage.

The components associated with the safety system 200 as shown in FIG. 2 are illustrated for ease of explanation and by way of example and not limitation. The safety system 200 may include additional, fewer, or alternate components as shown and discussed herein with reference to FIG. 2. Moreover, one or more components of the safety system 200 may be integrated or otherwise combined into common processing circuitry components or separated from those shown in FIG. 2 to form distinct and separate components. For instance, one or more of the components of the safety system 200 may be integrated with one another on a common die or chip. As an illustrative example, the one or more processors 102 and the relevant memory accessed by the one or more processors 214A, 214B, 216, 218 (e.g. the one or more memories 202) may be integrated on a common chip, die, package, etc., and together comprise a controller or system configured to perform one or more specific tasks or functions. Again, such a controller or system may be configured to execute the various to perform functions related to issuing warnings and/or controlling various aspects of the vehicle 100, as discussed in further detail herein, to present relevant warnings and/or to control of the state of the vehicle 100 in which the safety system 200 is implemented.

In some aspects, the safety system 200 may further include components such as a speed sensor 108 (e.g. a speedometer) for measuring a speed of the vehicle 100. The safety system 200 may also include one or more inertial measurement unit (IMU) sensors such as e.g. accelerometers, magnetometers, and/or gyroscopes (either single axis or multiaxis) for measuring accelerations of the vehicle 100 along one or more axes, and additionally or alternatively one or more gyro sensors, which may be implemented for instance to calculate the vehicle's ego-motion as discussed herein, alone or in combination with other suitable vehicle sensors. These IMU sensors may, for example, be part of the position sensors 105 as discussed herein. The safety system 200 may further include additional sensors or different sensor types such as an ultrasonic sensor, a thermal sensor, one or more radar sensors 110, one or more LIDAR sensors 112 (which may be integrated in the head lamps of the vehicle 100), digital compasses, and the like. The radar sensors 110 and/or the LIDAR sensors 112 may be configured to provide pre-processed sensor data, such as radar target lists or LIDAR target lists. The third data interface (e.g., one or more links 224) may couple the speed sensor 108, the one or more radar sensors 110, and the one or more LIDAR sensors 112 to at least one of the one or more processors 102.

### B. Autonomous Vehicle (AV) Map Data and Road Experience Management (REM)

Data referred to as REM map data (or alternatively as Roadbook Map data or AV map data), may also be stored in a relevant memory accessed by the one or more processors 214A, 214B, 216, 218 (e.g. the one or more memories 202) or in any suitable location and/or format, such as in a local or cloud-based database, accessed via communications between the vehicle and one or more external components (e.g. via the transceivers 208, 210, 212), etc. It is noted that although referred to herein as “AV map data,” the data may be implemented in any suitable vehicle platform, which may include vehicles having any suitable level of automation (e.g. levels 0-5), as noted above.

Regardless of where the AV map data is stored and/or accessed, the AV map data may include a geographic location of known landmarks that are readily identifiable in the navigated environment in which the vehicle 100 travels. The location of the landmarks may be generated from a historical accumulation from other vehicles driving on the same road that collect data regarding the appearance and/or location of landmarks (e.g. “crowd sourcing”). Thus, each landmark may be correlated to a set of predetermined geographic coordinates that has already been established. Therefore, in addition to the use of location-based sensors such as GNSS, the database of landmarks provided by the AV map data enables the vehicle 100 to identify the landmarks using the one or more image acquisition devices 104. Once identified, the vehicle 100 may implement other sensors such as LIDAR, accelerometers, speedometers, etc. or images from the image acquisitions device 104, to evaluate the position and location of the vehicle 100 with respect to the identified landmark positions.

Furthermore, and as noted above, the vehicle 100 may determine its own motion, which is referred to as “ego-motion.” Ego-motion is generally used for computer vision algorithms and other similar algorithms to represent the motion of a vehicle camera across a plurality of frames, which provides a baseline (i.e. a spatial relationship) that can be used to compute the 3D structure of a scene from respective images. The vehicle 100 may analyze the ego-motion to determine the position and orientation of the vehicle 100 with respect to the identified known landmarks. Because the landmarks are identified with predetermined geographic coordinates, the vehicle 100 may determine its location and position on a map based upon a determination of its position with respect to identified landmarks using the landmark-correlated geographic coordinates. Doing so provides distinct advantages that combine the benefits of smaller scale position tracking with the reliability of GNSS positioning systems while avoiding the disadvantages of both systems. It is further noted that the analysis of ego motion in this manner is one example of an algorithm that may be implemented with monocular imaging to determine a relationship between a vehicle's location and the known location of known landmark(s), thus assisting the vehicle to localize itself. However, ego-motion is not necessary or relevant for other types of technologies, and therefore is not essential for localizing using monocular imaging. Thus, in accordance with the aspects as described herein, the vehicle 100 may leverage any suitable type of localization technology.

Thus, the AV map data is generally constructed as part of a series of steps, which may involve any suitable number of vehicles that opt into the data collection process. As each vehicle collects data, the data is classified into tagged data points, which are then transmitted to the cloud or to another suitable external location. A suitable computing device (e.g. a cloud server) then analyzes the data points from individual drives on the same road, and aggregates and aligns these data points with one another. After alignment has been performed, the data points are used to define a precise outline of the road infrastructure. Next, relevant semantics are identified that enable vehicles to understand the immediate driving environment, i.e. features and objects are defined that are linked to the classified data points. The features and objects defined in this manner may include, for instance, traffic lights, road arrows, signs, road edges, drivable paths, lane split points, stop lines, lane markings, etc. to the driving environment so that a vehicle may readily identify these features and objects using the AV map data. This information is then compiled into a Roadbook Map, which constitutes a bank of driving paths, semantic road information such as features and objects, and aggregated driving behavior.

A map database 204, which may be stored as part of the one or more memories 202 or accessed via the computing system 150 via the link(s) 140, for instance, may include any suitable type of database configured to store (digital) map data for the vehicle 100, e.g., for the safety system 200. The one or more processors 102 may download information to the map database 204 over a wired or wireless data connection (e.g. the link(s) 140) using a suitable communication network (e.g., over a cellular network and/or the Internet, etc.). Again, the map database 204 may store the AV map data, which includes data relating to the position, in a reference coordinate system, of various landmarks such as objects and other items of information, including roads, water features, geographic features, businesses, points of interest, restaurants, gas stations, etc.

The map database 204 may thus store, as part of the AV map data, not only the locations of such landmarks, but also descriptors relating to those landmarks, including, for example, names associated with any of the stored features, and may also store information relating to details of the items such as a precise position and orientation of items. In some cases, the AV map data may store a sparse data model including polynomial representations of certain road features (e.g., lane markings) or target trajectories for the vehicle 100. The AV map data may also include stored representations of various recognized landmarks that may be provided to determine or update a known position of the vehicle 100 with respect to a target trajectory. The landmark representations may include data fields such as landmark type, landmark location, etc., among other potential identifiers. The AV map data may also include non-semantic features including point clouds of certain objects or features in the environment, and feature point and descriptors.

The map database 204 may be augmented with data in addition to the Roadbook Map data, and/or the map database 204 and/or the Roadbook Map data may reside partially or entirely as part of the remote computing system 150. As discussed herein, the location of known landmarks and map database information, which may be stored in the map database 204 and/or the remote computing system 150, may form what is referred to herein as “AV map data,” “REM map data,” or “Roadbook Map data.” The one or more processors 102 may process sensory information (such as images, radar signals, depth information from LIDAR or stereo processing of two or more images) of the environment of the vehicle 100 together with position information, such as GPS coordinates, the vehicle's ego-motion, etc., to determine a current location, position, and/or orientation of the vehicle 100 relative to the known landmarks by using information contained in the AV map. The determination of the vehicle's location may thus be refined in this manner. Certain aspects of this technology may additionally or alternatively be included in a localization technology such as a mapping and routing model.

### 1. Technological Overview and Summary

Large neural networks trained in the overparameterized regime are able to fit noise to zero train error. Recent work has empirically observed that such networks behave as “conditional samplers” from the noisy distribution. That is, the networks replicate the noise in the training data to unseen examples. The following disclosure provides a theoretical framework for studying this conditional sampling behavior in the context of learning theory. The notion of such samplers is related to knowledge distillation, where a “student” network imitates the outputs of a “teacher” on unlabeled data. It is demonstrated that samplers, while being bad classifiers, can be good teachers. Concretely, it is shown that distillation from samplers is ensured to produce a student which approximates the Bayes optimal classifier. Finally, it is demonstrated that some common learning algorithms (e.g., Nearest-Neighbors and Kernel Machines) can generate samplers when applied in an overparameterized regime.

The notion of samplers is related to knowledge distillation methods. In short, knowledge distillation is the process of training a “teacher” network on a small labeled dataset and using its predictions to label a large unlabeled dataset, on which a student network is trained to imitate the output of the teacher. As further described herein, by taking an ensemble of samplers as a teacher for knowledge distillation produces a student network with minimal error with respect to the Bayes optimal classifier. The embodiments as discussed herein further leads to a new algorithm for knowledge distillation, where a teacher is randomly selected from a fixed pool to label each sample, which accelerates the training process in practice. It is further shown that this new algorithm is guaranteed to find a “student” with low error.

1.1 Learning Theory of Conditional Samplers. A study of conditional sampling is provided in the context of computational learning theory. The problem of conditional-sampling is introduced, and the sample complexity of learning a sampler is defined. Next, positive and negative results are presented in this new setting. For example, it is shown that distributions exist where sampling is much easier than classification, requiring far fewer samples. However, if we allow polynomial blowup in sample-size and runtime, a sampler can be “boosted” to a good classifier, showing that if finding a classifier is computationally intensive then sampling is also computationally intensive.

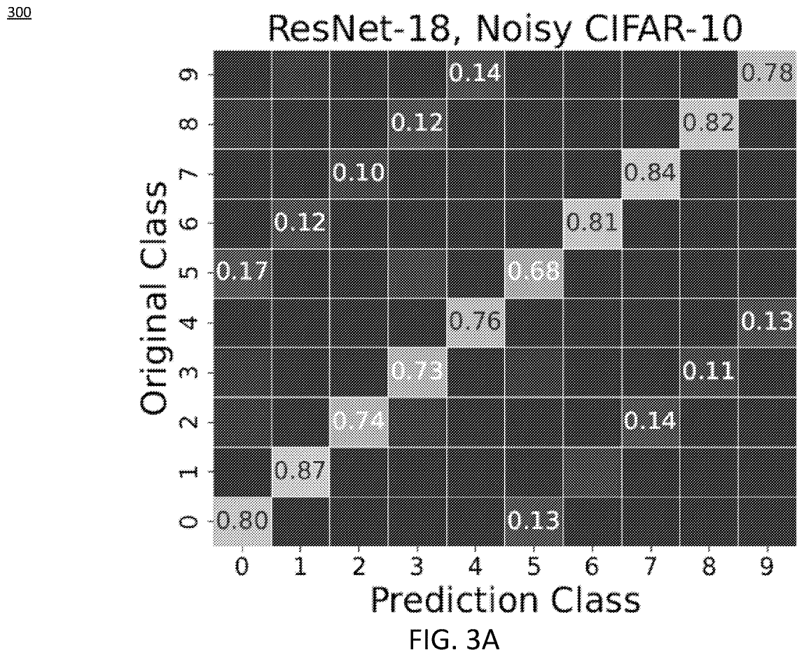

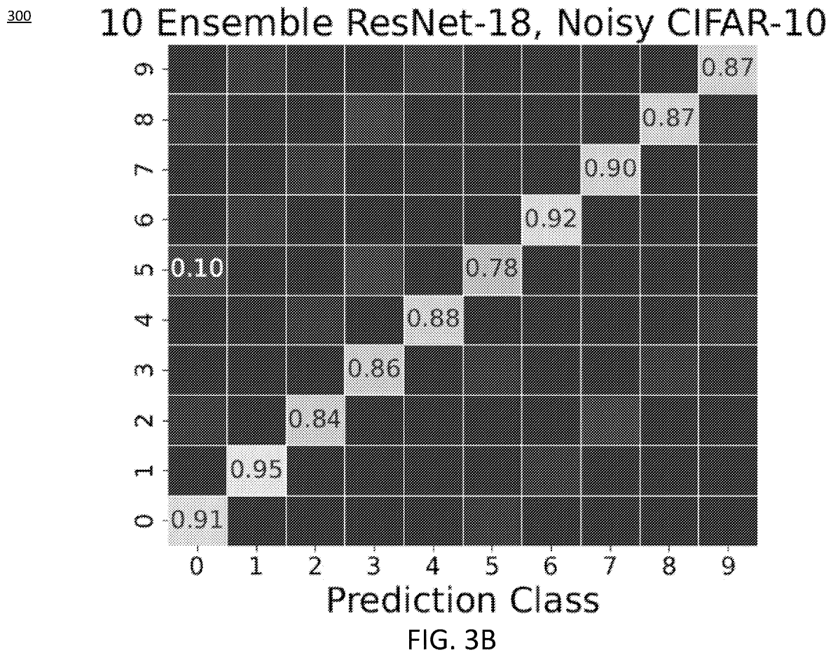

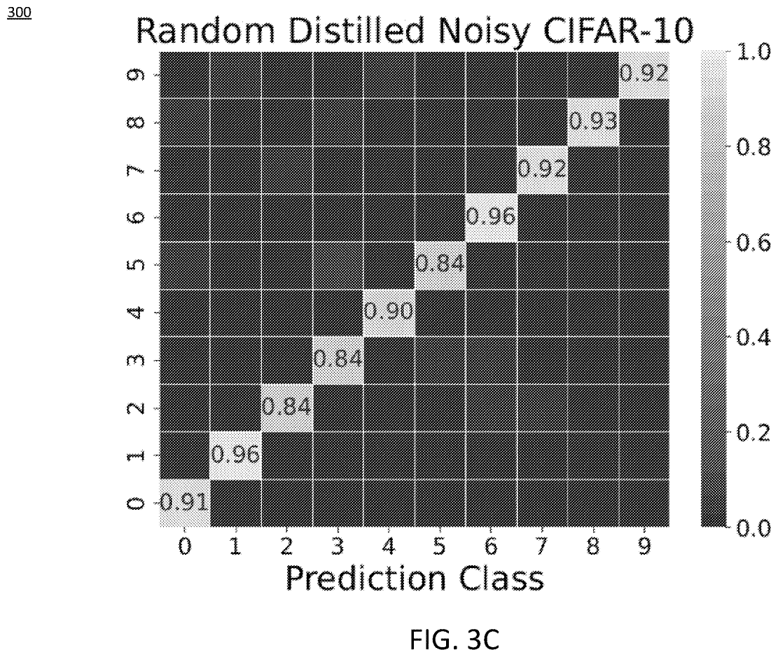

1.2 Theory of Knowledge Distillation. One way to boost a sampler into a good classifier is to run an ensemble of samplers at inference time (see FIG. 3B), which is costly. It is shown that by performing distillation from an ensemble of teachers, it is possible to find a student with low error with respect to the Bayes optimal. This shows that teacher networks in ensemble-distillation need not be good classifiers, but just good samplers. Finally, the embodiments described herein comprise an algorithm for distillation, in which each sample is labeled by a random teacher from a fixed pool (see FIG. 3C). The quantitative bounds on the sample complexity of teaching and learning in this setting is further discussed herein, for both ensemble-distillation and distillation from a random teacher.

1.3 Theory of Sampler Algorithms. As further discussed herein, several classical learning algorithms provably produce good conditional samplers, and their sample complexity is analyzed in terms of standard problem parameters (e.g. distributional smoothness). Specifically, it is shown that the 1-Nearest-Neighbor algorithm is a sampler, and the analysis is then extended to k-Nearest-Neighbors as well. Furthermore, it is shown that under some distributional assumptions, Lipschitz classes such as linear methods, kernels, and neural networks may also behave like samplers.

1.4 Knowledge Distillation. Knowledge Distillation for deep learning was proposed in Hinton [14]. Since then, a large body of work showed its practical benefits for various machine learning tasks (See [10], [23], [27], [28], [30]). Nonetheless, from a theoretical perspective, understanding why and when distillation works remains a mystery. The success of distillation has been attributed to the fact that the soft labels of the teacher passing additional information on the input. Menon (See [18]) claims that when the teacher approximates the Bayes class-probabilities, distillation is possible. Our results show that even when the teachers are far from the Bayes optimal prediction (i.e., when teachers are noisy samplers from the distribution), we can find a student with low levels of noise through distillation. Another work by Wei (See [28]) shows that, assuming the data distribution has good continuity within each class, self-distillation is possible. However, it is not clear when such assumption is actually satisfied. The work of Lopez-Paz (See [17]) relates the notion of privileged information to knowledge distillation. A work by Frei et al. (See [8]) shows that self-training can boost weak learners, when the target is a linear classifier over a mixture model distribution. Other works ([7], [19], [32]) study distillation as a regularization method, forcing the student to learn under a “smoother” loss landscape.

1.5 Learning with Noise. Learning under corrupted labels is a well-studied research area in the literature ([1], [9]). A notable example is the work of Blum [5] and [15], showing how statistical query algorithms can be leveraged to learn under noisy labels. A growing number of works study the effects of noise on deep learning, as well as methods to learn under label noise (see Song [26] for a survey). However, most of these works do not leverage distillation for label noise robustness, as we suggest in our work. Work done by Haase-Schutz et al. (See [12]), shows that an iterative process of training and re-labeling can combat label noise. However, this work focuses on empirical study.

2. Sampling as a Learning Problem. Let [symbol] be the input space and [symbol] ={±1} be the label space (for simplicity, under appropriate assumptions most of the results may be extended to multiclass). A hypothesis class [symbol] is some class of functions from [symbol] to [symbol] . A learning algorithm [symbol] takes a sequence of m samples S∈( [symbol] × [symbol] )^{m} and outputs some hypothesis h: [symbol] > [symbol] . IT is denoted by [symbol] (S) the hypothesis that [symbol] outputs when observing the sample S. For some distribution [symbol] over [symbol] × [symbol] , the X marginal is denoted as [symbol] and denote the Bayes optimal classifier by

$${f}_{𝒟}^{*} ( x ) := arg {max}_{y} {ℙ}_{𝒟} ( y \vert x ) .$$

This assumes that ties are broken arbitrarily.

When [symbol] is a distribution where the label is not a deterministic function of the input, [symbol] may be thought of as a noisy version of some clean distribution [symbol] *, where each input is correctly labeled. Naturally, it is assumed that the probability of seeing the right label is greater than seeing a wrong one. In other words, [symbol] * has the same marginal distribution over

$$𝒳 ( i . e . , {𝒟}_{𝒳} = {𝒟}_{𝒳}^{*} ) ,$$

and is labeled by the Bayes optimal classifier of [symbol] . That is, sampling (x, y)˜ [symbol] is given

$$b y x - {𝒟}_{χ} and y = {f}_{𝒟}^{*} ( x ) .$$

The “noise” of the distribution [symbol] is denoted as

$$η𝒟 = := {ℙ}_{( x , y ) \sim 𝒟} [ y \neq {f}_{𝒟}^{*} ( x ) ] .$$

Also considered is the margin of the distribution, which defines the difference in probability between correct and wrong label for each sample. Namely, for some δ≥0, let γ_{δ}( [symbol] ) be the supremum over γ>0 such that the following Equation satisfied:

$${ℙ}_{x ∼ {𝒟}_{𝒳}} [ {ℙ}_{𝒟} {f}_{𝒟}^{*} ( x \vert x ) < {max}_{y \neq {f}_{𝒟}^{*} ( x )} {ℙ}_{𝒟} {f}_{𝒟}^{*} ( y \vert x ) + γ ] \leq δ$$

Specifically, the following may be denoted γ( [symbol] ): =γ₀( [symbol] ). It is typically assumed that the input distribution has a strictly positive margin γ( [symbol] )>0, so for every sample the probability to see the correct label is greater than the probability to see a wrong label. An objective in this setting is to approximate the Bayes optimal classifier of [symbol] . In other words, the aim is to minimize the 0-1 loss on the clean distribution [symbol] * in accordance with the Equation 1 below as follows:

$${ℒ}_{{𝒟}^{*}} ( h ) := {ℙ}_{( x , y ) ∼ 𝒟} [ h ( x ) \neq {f}_{𝒟}^{*} ( x ) ] = {ℙ}_{( x , y ) ∼ 𝒟} [ h ( x ) \neq y ] \qquad Eqn . 1$$

In this way, the learning algorithm has access to samples from the noisy distribution [symbol] , but needs to achieve good loss on the clean distribution [symbol] *. As used herein, the term “learner” is defined in this setting to be an algorithm that minimizes Eqn. 1 using a finite number of samples. Thus, the following Definition is provided.

Definition 1: For some learning algorithm [symbol] and some distribution D over [symbol] × [symbol] , [symbol] is a learner for [symbol] if there exists a function m: (0,1)→ [symbol] such that for every ε∈(0,1), taking m≥m(ε), we get [symbol] ^{m} [symbol] *( [symbol] ( [symbol] ))≤ε.

In this case, we call m(·) the sample complexity of [symbol] with respect to [symbol] . Additionally, for some class [symbol] of distributions over [symbol] × [symbol] , we say that is a learner for [symbol] if there is some m(·) such that [symbol] is a learner with sample complexity m(·) for every [symbol] ∈ [symbol] .

It is noted that this definition of a learner is similar to the notion of an asymptotically consistent estimator. However, this definition explicitly accounts for the sample complexity. To give an illustrative example, let us consider agnostic learning using the ERM rule, namely: ERM_{H}(S)= [symbol] L_{S}(h). For some hypothesis class [symbol] and some margin>0, let [symbol] ( [symbol] , γ) be the class of distributions such that for every [symbol] ∈ [symbol] ( [symbol] , γ) we have γ [symbol] ≥γ and

$${f}_{𝒟}^{*} ∈ .$$

Namely, [symbol] ( [symbol] ,γ is the class of distributions such that for every [symbol] ∈ [symbol] ( [symbol] ,γ) we have γ [symbol] >γ and classifier comes from [symbol] . The following theorem states that finite VC-dimension and a non-zero margin form a sufficient condition for learnability with noise.

Theorem 2: There exists a constant C>0 such that for every hypothesis class [symbol] with VC( [symbol] )<∞, ERM_{H} is a “learner” for [symbol] ( [symbol] , γ) with sample complexity

$$m ( ε ) = C$$

The proof of Theorem 2 is provided in the Appendix at the end of this disclosure. The main idea is the following lemma (whose proof is also in the Appendix), shows that the margin assumption connects a small relative error with respect to [symbol] to a small absolute error with respect to [symbol] *.

Lemma 3. Fix some distribution [symbol] , and let h* represent the Bayes optimal classifier for D. Assume that γ_{δ}( [symbol] )>0. Then, for every h such that L [symbol] (h)≤L [symbol] (h*)+ε, it holds that

$${L}_{{𝒟}^{*}} ( h ) \leq \frac{ε}{{γ}_{δ} ( 𝒟 ) + δ} .$$

Combining this lemma with the Fundamental Theorem of Learning Theory (see Shalev-Shwartz and Ben-David (See [14]) yields Theorem 2. From this theorem, we see that given more samples than the VC-dimension (often corresponding to the number of parameters), learning is possible. However, complex classifiers with large VC-dimension such as neural networks are often trained in the overparameterized regime, when the number of parameters exceeds the number of samples. In this regime, the bound of Theorem 2 becomes vacuous. That said, this does not rule out the possibility of distribution-dependent sample complexity bounds using other measures of complexity (e.g., Rademacher complexity).

2.1 Samplers. As previously mentioned, neural networks trained on noisy data replicate the noise to unseen samples as well, behaving like samplers from the noisy distribution. Thus, a formal definition of a sampler is provided for some distribution [symbol] , with a similar definition as used in Nakkiran and Bansal (see [20]). For some learning algorithm [symbol] , some number m∈ [symbol] and some distribution [symbol] over [symbol] × [symbol] , define the distribution [symbol] (Dm) over [symbol] × [symbol] , where (x, y)˜ [symbol] ( [symbol] ^{m}) is given by sampling S˜ [symbol] ^{m} sampling x˜ [symbol] ₓ and setting y= [symbol] (S)(x). Namely, [symbol] ( [symbol] ^{m}) is the distribution given by (re)-labeling [symbol] using a hypothesis generated by [symbol] when observing a random sample of size m. Using these notations, we define a sampler algorithm for the distribution [symbol] as follows:

Definition 4: For some learning algorithm [symbol] and some distribution [symbol] over [symbol] × [symbol] , we say that [symbol] is a sampler for [symbol] if there exists \tilde{m}: (0,1)→ [symbol] such that for every ε∈(0,1) taking m≥\tilde{m}(ε) we get:

$$TV ( 𝒜 ( {𝒟}^{m} ) , 𝒟 ) \leq ε ,$$

where TV represents the Total Variation Distance. Then, we call \tilde{m} the sample complexity of [symbol] with respect to [symbol] . Additionally, for some class [symbol] of distributions over [symbol] × [symbol] , we say that [symbol] is a sampler for [symbol] if there exists m(·) such that [symbol] is a sampler with sample complexity \tilde{m}(·) for each [symbol] ∈ [symbol] .

So, a sampler for [symbol] is an algorithm that generates a distribution similar to [symbol] (the noisy input distribution) when labeling new samples. A primary example for a sampler is the 1-Nearest-Neighbor algorithm: since 1-NN outputs the (possibly corrupted) label of the closest neighbor, its prediction behaves like sampling from [symbol] (y|x) (see Section 4). FIGS. 3A-3C show that neural networks behave similarly to samplers when trained on a noisy version of the CIFAR-10 dataset.

Given the above definition, it can be easily shown that, instead of approximating the Bayes optimal prediction, a sampler preserves the noise rate of the original distribution.

Lemma 5. Let [symbol] be a sampler [symbol] with sample complexity \tilde{m}. Then, for m≥\tilde{m}(ε),

$$η ( 𝒟 ) - ε \leq {𝔼}_{S ∼ {𝒟}^{m}} {L}_{{𝒟}^{*}} ( ( S ) ) \leq η ( 𝒟 ) + ε$$

While a sampler for [symbol] is not a good learner (in the sense of Definition 1 above), it does have some favorable properties. Primarily, it can take significantly fewer samples to get a sampler than it would take to get a learner, hence making the study of samplers more suitable for the overparameterized regime. In fact, in the extreme case one could get a sampler using only a single sample from the distribution, while getting a learner for the same distribution would require an arbitrarily large number of samples. Indeed, fix b∈{±1} and γ∈(0,1), and let [symbol] _{b} represent the distributions concentrated on a single sample (x,y), with label y∈{±1} such that

$${ℙ}_{{𝒟}_{b}} ( y = 1 ) = \frac{1 + b γ}{2} .$$

To get a sampler from [symbol] _{b} it clearly suffices to take a single sample (x, y), and return the constant function y. To find the Bayes optimal for the distribution [symbol] _{b}, on the other hand, any algorithm needs

$$Ω ( \frac{1}{{γ}^{2}} )$$

sample. Using this observation, we show the following result:

Theorem 6. For every M>0, there exists a class of distributions [symbol] _{M} such that:

There exists a sampler for [symbol] _{M} with sample complexity \tilde{m}≡1.

Any learner for [symbol] _{M} has sample complexity satisfying m(1/8)>=M.

### 2.2. Teachers

Motivated by the observed behavior of neural networks in the overparemeterized regime, we defined the notion of samplers. We showed that samplers can be much more sample efficient than learners, at the cost of giving noisy predictions. Next, we will show that while samplers are in and of themselves bad classifiers, they can still be good teachers. That is, we can use samplers to label a large unlabeled dataset and train a student classifier on this new dataset. This process is often referred to as knowledge distillation, and it has been shown to work remarkably well in practice (See [23], [29]). The following definition captures the notion of a (good) teacher.

Definition 7. For some learning algorithm [symbol] , some distribution [symbol] over [symbol] × [symbol] , we say that [symbol]
is a teacher for [symbol] if there exists a function \tilde{m}: (0,1)²→ [symbol] such that for every ε, τ∈(0,1), taking m≥\tilde{m}(ε, τ) the following holds:

$${ℒ}_{{𝒟}^{*}} ( {f}_{𝒜 ( {𝒟}^{m} )}^{*} = {ℙ}_{x ∼ 𝒟} [ {f}_{𝒟}^{*} ( x ) \neq {f}_{𝒜 ( {𝒟}^{m} )}^{*} ( x ) ] \leq ε . \qquad 1$$

$${γ}_{ε} ( ( {𝒟}^{m} ) ) \geq γ ( 𝒟 ) - τ . \qquad 2$$

Additionally, for some class [symbol] of distributions over [symbol] × [symbol] , we say that [symbol] is a teacher for [symbol] if there is some m(·,·) such that [symbol] is a teacher with sample complexity m(·,·) for every [symbol] ∈ [symbol] .

The first condition in the above definition means that the Bayes optimal of the original distribution and the distribution induced by the teacher are close. The second condition means that the probability mass of low margin samples from the distribution labeled by the teacher is small. Intuitively, an algorithm satisfying Definition 7 is a good teacher since the distribution it induces is “similar” to the original distribution. Hence, if the student finds a good hypothesis on the teacher induced distribution, its hypothesis is also good with respect to the original distribution.

In Section 3 below a further discussion is provided regarding when and how teachers can be used for distillation, giving guarantees for getting students with a small error with respect to the clean distribution [symbol] *. However, for clarity it is first described how samplers are indeed good teachers.

Theorem 8. Let [symbol] be a sampler for [symbol] with sample complexity m(·) and margin γ. Then, [symbol] is a teacher for [symbol] with sample complexity

$$\tilde{m} ( ε , τ ) = m ( ε \cdot min ( \frac{τ}{2} , γ ) ) .$$

The main idea behind the proof of Theorem 8 is that, given an example with probability mass p, the “cost” (in terms of TV) of flipping the sample's label with respect to the Bayes optimal

$${f}_{𝒟}^{*}$$

is at least p·γ. Since the TV “budget” is limited by εγ, only a probability mass of ε of the distribution may be flipped.

Finally, before moving on to discuss the implication of the results, it is shown that learners are also good teachers. This is almost immediate, since learners approximate the Bayes optimal classifier, and hence can be used to train students to similarly imitate the Bayes classifier.

Theorem 9. Let [symbol] be a learner for [symbol] with sample complexity m(·). Then, [symbol] is a teacher for [symbol] with sample complexity

$$\tilde{m} ( ε , τ ) = m ( \frac{ε ( 1 - γ ( 𝒟 ) + τ )}{2} ) .$$

To conclude, Theorem 8 and Theorem 9 show that, to some extent, a teacher is an “interpolation” between a sampler and a learner.

### 3. Distillation from Teachers

To summarize, the notion of a teacher was defined, and it was illustrated that both samplers and learners are teachers. Now, it is shown how teachers (and in particular, samplers) can be used to find good learners. First, it is shown that an ensemble of teachers can be used to get a good learner by simply outputting the majority vote of the ensemble. Next, it is shown that using the ensemble to label a new set of unlabeled samples (i.e., performing knowledge distillation) guarantees finding a student with small loss, assuming the Bayes optimal classifier comes from the hypothesis class learned by the student. Such process is advantageous, since it reduces the computational cost of running the ensemble at inference time, and also allows for using a different hypothesis class for the student (for example when using a student network of smaller size, e.g., Gou et al. [11]). Finally, it is shown that distillation can also be achieved by labeling samples using a teacher that is randomly selected from a fixed (e.g. predetermined) set of teachers, a method that has some computational benefits at training time. This novel technique for distillation has not been previously suggested in prior work and provides significant advantages, as discussed herein.

### 3.1. Ensembles of Teachers

In this Section, it is shown how an ensemble of teachers can be used to get accurate predictions with respect to the Bayes optimal predictor. Given some k samples S₁, . . . , Sₖ˜ [symbol] ^{m}, each one of size m, a learning algorithm [symbol] may be executed to get k different hypothesis h₁, . . . , hₖ, where hᵢ:= [symbol] (Sᵢ). Observe the ensemble hypothesis, which outputs the majority vote of the ensemble members in accordance with the following relationship:

$${h}_{ens} ( x ) = {arg max}_{y ϵ𝒴} {\sum }_{i} 1 \{ {h}_{i} ( x ) = y \}$$

The notation [symbol] ₑₙₛ(S₁ . . . , Sₖ):=hₑₙₛ to denote this ensemble hypotheses. The following

Theorem states that the ensemble hypothesis has a good loss on average, when using a large enough ensemble of teachers:

Theorem 10. Assume that [symbol] is a teacher for some distribution [symbol] with complexity \tilde{m}. Then, for all ε∈(0,1), taking

$$m \geq \tilde{m} ( \frac{ε}{3} , \frac{γ ( 𝒟 )}{2} ) and \frac{16 log ( \frac{3}{ε} )}{{γ ( 𝒟 )}^{2}} ,$$

the following relationship is obtained:

$${𝔼}_{{S}_{1} , … , {S}_{k} ∼ {𝒟}^{m}} {L}_{{𝒟}^{*}} ( {ens}_{} ( {S}_{1} … , {S}_{k} ) ) \leq ε$$

A sketch of the proof is now provided. For some ε∈ [symbol] , let yᵢ be the prediction of the i-th teacher, y̅ and let be the average of the predictions, namely

$$\overline{y} = \frac{1}{k} {\sum }_{i} {y}_{i} .$$

It is observed that hₑₙₛ=sign(y̅), and additionally [symbol] [y|x]. Now, since [symbol] is a teacher we get [symbol] [y|x]≈ [symbol] [y|x] (with high probability over the choice of x), and by concentration bounds this implies that with high probability that hₑₙₛ(x) provides the Bayes optimal prediction

$$( i . e . , {h}_{e n s} ( x ) = {f}_{𝒟}^{*} ( x ) ) .$$

So, Theorem 10 shows that if [symbol] is a teacher for [symbol] , then [symbol] ₑₙₛ with k≥\tilde{Ω} [symbol] ² is a learner for [symbol] . It is noted that \tilde{Ω} is used to hide constant and logarithmic factors. More generally, if we have a teacher for some distribution [symbol] with positive margin, this implies that there exists a learner for the same distribution. The inverse of this statement gives another interesting result—if no algorithm can learn some problem, then getting a teacher (or sampler) is also difficult. Formally, let [symbol] be a class of distributions over [symbol] × [symbol] such that for all [symbol] ∈ [symbol] it holds that γ( [symbol] )≥γ. Then, if there is no learner for [symbol] , there is no teacher or sampler for [symbol] . Additionally, a similar result holds for problems which are computationally intensive (i.e. difficult) to learn. That is, if there is no learner for [symbol] that runs in polynomial time, then there is no poly-time teacher or sampler for [symbol] . Observe that the condition that γ( [symbol] )≥γ for all for all [symbol] ∈ [symbol] in the previous statement is necessary. Indeed, taking

$$𝒫 = {U}_{M = 1}^{∞} ,$$

where [symbol] _{M} is the distribution class guaranteed by Theorem 6, gives a class [symbol] such that there is a sampler for [symbol] with sample complexity \tilde{m}≡1, but there is no learner for [symbol] .
3.2. Distillation from Ensembles

To summarize, it was shown that an ensemble of k=\tilde{Ω}(γ⁻²) teachers gives a classifier that approximates the Bayes optimal predictor. This, however, incurs a k factor in computational cost at inference time. To prevent this, the embodiments discussed herein use the ensemble to label new unlabeled data, and train a new classifier to imitate the ensemble. This moves the computational burden from inference time to training time.

For example, if we fix some class [symbol] , an Ensemble-Pseudo-Labeling (EPL) algorithm in accordance with an embodiment may be provided as follows:
1. For some k, m∈ [symbol] , sample S₁, . . . , Sₖ˜ [symbol] ^{m}.
2. Run [symbol] on S₁, . . . , Sₖ, and let hₑₙₛ= [symbol] ₑₙₛ(S₁, . . . , Sₖ).
3. Take S′ to be a set of m′ unlabeled samples sampled from [symbol] , and label it using hₑₙₛ.
4. Denote by \tilde{S} the pseudo-labeled set. Run [symbol] on the set \tilde{S} and return
h:= [symbol] (\tilde{S}).

Intuitively, since hₑₙₛ approximates the Bayes optimal classifier (see Theorem 10), the labels
for the new dataset S′ are mostly correct. In other words, the pseudo-labeled set \tilde{S} comes from a distribution that is close to the clean distribution [symbol] *. When using pseudo-labels, it is enough to use unlabeled data, which is often abundant, so \tilde{S} can be much larger than our original labeled dataset. In this case, we no longer need to work in the overparameterized regime, so [symbol] is guaranteed to achieve good performance by standard VC bounds. This observation is captured in Theorem 11:

Theorem 11. For hypothesis class [symbol] with VC( [symbol] )<∞, and let [symbol] ∈ [symbol] ( [symbol] , γ) for some γ>0. Let [symbol] be a teacher for [symbol] with distributional sample complexity \tilde{m}. Then, there exists a constant C>0 such that for every ε∈(0,1), running the EPL algorithm with parameters m≥

$$\tilde{m} ( \frac{ε}{12} , \frac{γ}{2} ) , {m}^{′} \geq C \frac{VC ( ℋ ) + log ( \frac{1}{ε} )}{{ε}^{2}} and k \geq \frac{16 log ( \frac{12}{ε} )}{{γ}^{2}}$$

returns a hypothesis h satisfying [symbol] _{S}_{₁}_{, . . . , S}_{ₖ}_{,\tilde{S}}L_{D*}(h)≤ε.
3.3. Distillation from Random Teachers

While the EPL algorithm moves the computation cost from inference to training, there remains a k factor for labeling each sample. Instead, in an embodiment samples are labeled by selecting a random classifier from the ensemble. Then, only one classifier is run per sample. So, the Random-Pseudo-Labeling (RPL) is defined similarly to EPL, except that for each sample x in the unlabeled dataset S′, h˜{h₁, . . . , hₖ,} is selected and x is labeled by h(x).

To understand why this method works, we can think of S′ as coming from a distribution [symbol] , defined by sampling x˜ [symbol] and sampling y such that [symbol] [y|x]= [symbol] _{i˜[k]}[hᵢ(x)]. By the properties of the teacher, using concentration arguments as in Theorem 10, the distribution [symbol] is close to the noisy distribution [symbol] . However, as mentioned before, the advantage of using S′˜ [symbol] is that a much larger set of unlabeled data may be used, in which case the result of Theorem 2 can be applied to show that the above algorithm finds a hypothesis with good error. This is stated in the following result:

Theorem 12. For hypothesis class [symbol] with VC( [symbol] )<∞. Let [symbol] ∈ [symbol] ( [symbol] , γ) for γ>0. Let [symbol] be a teacher for [symbol] with distributional sample complexity \tilde{m}. Then, there exists a constant C>0 such that for every ε∈(0.1), running the RPL algorithm with parameters m≥

$$\tilde{m} ( \frac{ε γ}{54} , \frac{γ}{2} ) , {m}^{′} \geq C \frac{VC ( ℋ ) + log ( {ε}^{- 1} {γ}^{- 1} )}{{ε}^{2} {γ}^{2}} and k \geq \frac{128 log ( 36 {ε}^{- 1} {γ}^{- 1} )}{{γ}^{2}} returns h satisfying {𝔼}_{{S}_{1} , … , {S}_{k ,} \tilde{S}} {L}_{D} * ( h ) \leq ε$$

Compare the sample complexity of the above Theorem 12 with the sample complexity achieved by the EPL algorithm, stated in Theorem 11. At first glance, it seems that the gain from using the RPL algorithm is not clear, as it increases the number of unlabeled data by a factor of [symbol] (and also might increase the number of labeled samples).

This is not surprising, because a dataset labeled by a random classifier can be much noisier than a dataset labeled by the ensemble, and hence more samples are required in order to learn. Note, that since k≥\tilde{Ω} [symbol] , the randomized labeling takes 1/k compute per sample relative to the ensemble labeling, it will, however, need to label an order of k times more samples.

It is noted that there are computational benefits to using the random approach, as it allows the training and labeling to be performed in parallel without a significant increase in computational processing (e.g., 2 GPU cores may be sufficient to train in parallel without any loss of time). On the other hand, labeling a dataset using the ensemble requires one to either increase the computation by k (applying parallelism), or otherwise wait until the full dataset is labeled, and only then start the distillation process. Finally, the embodiments described herein and accompanying experiments show that the gain from ensemble labeling over random labeling, as captured by the final accuracy of the trained student, is not so significant (see Table 1 below).

TABLE 1

| Experiment | Test Accuracy ± std |
|---|---|
| One Teacher | 0.868 ± 5e−3 |
| 5 Random Teachers | 0.898 ± 2e−3 |
| 10 Random Teachers | 0.900 ± 2e−3 |
| 5 Teacher Ensemble | 0.899 ± 2e−3 |
| 10 Teacher Ensemble | 0.902 ± 1e−3 |
| 10-Ensemble Inference | 0.878 |
| 10-Teacher Clean Ens. | 0.934 ± 0.8e−3 |
| Teacher Accuracy | 0.813 ± 4.7e−2 |

This suggests that in some particular cases (e.g., under further assumptions on the data distribution and/or the optimization algorithm), it is preferable to use the RPL algorithm.

### 4. Samplers Exist

Thus, it has been demonstrated that samplers can be good teachers. These can then be used for knowledge distillation, generating students which approximate the Bayes optimal prediction. To complete the picture, we now show that some known algorithms can be used to get samplers or teachers.

We start by studying the k-Nearest-Neighbor algorithm, and show that it is a teacher, when the underlying distribution has some Lipschitz property. We then analyze Lipschitz classes of functions (e.g., linear functions, kernels, and neural networks), and show that when the data is well-clustered, these algorithms can be teachers as well. In all cases, the sample complexity needed for the samplers or teachers is lower than the complexity required for learning.

### 4.1. Nearest Neighbor Algorithm

For some set S={(x₁, y₁), . . . , (xₘ, yₘ)}⊆X×Y, we denote [symbol] ={x₁, . . . , xₘ}. Fix some metric d over the space [symbol] . In this section, we assume that the metric space ( [symbol] ,d) satisfies the Heine-Borel property—that is, every closed and bounded set in [symbol] is compact. Specifically, the Heine-Borel property holds for [symbol] ⁿ where d is induced by some norm.

For some finite set S⊆X×Y, and some x∈X, denote d(x, S):= [symbol] d(x, x′) and π(x, S):=argmin_{(x′,y′)∈S}d(x, x′). Additionally, we define the set k−π(x, [symbol] )⊆S to be the set of k points in S that are closest to x. That is, k−π(x, S) is a set of size k such that for any (\tilde{x}, \tilde{y})∈S\k−π(x, S), it holds that d(x, x′)≤d(x, \tilde{x}). If there are multiple choices for such set, we choose one arbitrarily. For some distribution [symbol] , we say that [symbol] is λ-Lipschitz if for all x, x′∈supp( [symbol] ) and y∈ [symbol] it holds that | [symbol] [y|x]− [symbol] [y|x′]|≤λd(x, x′).

For some odd k≥1, define [symbol] _{k-NN}(S)(x):= [symbol] |(x′, y′)∈k−π(x, S), y′=ŷ|, i.e. [symbol] _{k-NN}(S) is the k-NN algorithm over sample S. We start by showing that the [symbol] _{1-NN}(S) is a sampler. The distributional sample complexity of [symbol] _{1-NN} depends on the number of ε balls that can cover a 1−δ mass of the distribution (Lemma 23 in the Appendix shows that this number is always finite). Given such cover, we can guarantee that with a large enough sample, we find a candidate sample in each of the balls that have non-negligible mass. In that case, if the distribution of labels does not change significantly in each ball, [symbol] _{1-NN} is indeed a sampler:

Theorem 13. Let [symbol] be some λ-Lipschitz distribution. Then, [symbol] _{1-NN} is a sampler for [symbol] .

Next, we study the k-Nearest-Neighbor algorithm for any odd k≥1. Similarly to the analysis of the 1-Nearest-Neighbor case, we show that a large enough sample guarantees at least k candidates in each of the E-ball covering the distribution. In this case, the prediction of the k-Nearest-Neighbor algorithm is the majority vote over the k neighbors in each ball. This, in fact, will grow closer to the Bayes optimal prediction as k grows, and therefore k-Nearest-Neighbor algorithm is not strictly speaking a sampler for k>1. However, we show that it is always a teacher:

Theorem 14. [symbol] be some λ-Lipschitz distribution. Then, [symbol] _{k-NN} is a teacher for [symbol] .

The core argument for proving Theorem 14, beyond the covering argument used in the 1-Nearest-Neighbor case, relies on using a variant of Condorcet's Jury (CJT) Theorem. Roughly speaking, the theorem states that the accuracy of the majority vote of a set of predictors is better than the average accuracy of the individual predictors. In the k-Nearest-Neighbor case, each of the k candidates casts a “vote”, and using CJT we show that this improves over the 1-Nearest-Neighbor prediction, which is already a sampler (and hence a teacher). Notice that this works for any k≥1, and we do not need to require k to be large enough, as would be required in order to get a learner.

Case Study: Limited Memory 1-NN. Now, we introduce a case study where applying the distillation methods studied in Section 3 results in a low-error student classifier, while at the same time using the same learning algorithm on the labeled data alone would maintain high levels of noise in the prediction. While this example is somewhat synthetic, we believe that it captures the behavior of samplers and teachers in practice. In this part, we take [symbol] ={0.1}ⁿ to simplify the analysis. It is noted that similar arguments can be applied to the case where [symbol] = [symbol] ⁿ.

Given our previous results, taking the 1-Nearest-Neighbor algorithm for the teacher seems to be a reasonable choice. However, using 1-NN as a student is problematic, since the VC-dimension of 1-NN classifiers is infinite. Thus, we consider a similar hypothesis class of 1-NN with limited memory. Let [symbol] _{b} be the class of 1-NN predictors with memory of size b. That is, for every h∈ [symbol] _{b} there is some S⊆X×Y such that S can be stored using b bits of memory, and for every x∈ [symbol] we have h(x)=ŷ, where ŷ is the label of the closest neighbour to x in S, namely (\hat{x}, ŷ)=π(x, S). Indeed, observe that [symbol] _{b} is a finite class of size 2^{b}, and therefore VC( [symbol] _{b})≤log(| [symbol] _{b}|)=b.

So, consider the following setting: let [symbol] be a distribution such that

$${f}_{𝒟}^{*} ϵ {ℋ}_{b} .$$

Assume that we draw a labeled dataset of size km from [symbol] (k subsets of size m), and that km·n<n (that is, we assume that the teacher is trained in the overparameterized regime). In this case, we can use [symbol] _{1-NN} as the algorithm for the teacher, and [symbol] as the student. It is noted that since we assume the teacher is trained in the overparameterized regime, there can be many ERM solutions, and we need to specify which one is chosen, so simply taking [symbol] is not enough. A natural choice in the overparameterized regime is to simply use [symbol] _{1-NN}.

Indeed, from everything described above it follows that both the EPL and the RPL algorithms will yield a student which approximates the Bayes optimal predictor. Additionally, observe that by Theorem 13, simply using [symbol] _{1-NN} over the entire training set will yield a sampler, which can be far from the Bayes optimal predictor (see Lemma 5).

Admittedly, one could always use k-NN (instead of 1-NN) and get a classifier that approximates the Bayes optimal prediction, when k is sufficiently large. However, in practice, “black-box” algorithms such as neural networks can behave like 1-NN (as shown in Nakkiran and Bansal (see [20]). In this case, what we show is essentially that knowledge distillation can take an algorithm that behaves like 1-NN and turn it into an algorithm that behaves like k-NN, without knowledge of the internals of the algorithm, and without suffering additional computational costs at inference time.

### 4.2. Bounded-Norm Infinite-Width ReLU Networks

We continue with investigating infinite-width neural-network with weights of bounded norm, following the setting studied in Savarese and Ongie (see [22], [24]). We define a ReLU network of width k and depth 2 by:

$${h}_{θ} ( x ) = {\sum }_{i = 1}^{k} {w}_{i}^{( 2 )} σ ( 〈 {w}_{i}^{( 1 )} , x 〉 + {b}_{i}^{( 1 )} ) + {b}^{( 2 )}$$

where θ=(k, W⁽¹⁾, W⁽²⁾, b⁽¹⁾, b⁽²⁾) and σ is the ReLU activation, namely σ(x)=max {x, 0}. As in Savarese et al. (See [24]), we consider the Euclidean norm of non-biased weights:

$$C ( θ ) = \frac{1}{2} {\sum }_{i = 1}^{k} ( {( {w}_{i}^{( 2 )} )}^{2} + {‖ {w}_{i}^{( 1 )} ‖}_{2}^{2} )$$

Now, consider fitting a sample S⊆ [symbol] × [symbol] with a network h_{θ} with C(θ) acting as regularization. Namely, observe the following objective function:

$$R ( S ) = {inf}_{θ} C ( θ ) such that {h}_{θ} ( x ) = y for all ( x , y ) ∈ S .$$

In the one-dimensional case, i.e. when [symbol] = [symbol] , Theorem 3.3 from Savarese (see [24]) shows that R(S) gives the linear spline interpolation of the data points. Namely, let \hat{θ}: =R(S), and assume that S={(x₁, y₁), . . . , (xₘ>yₘ)} is sorted such that x₁<x₂< . . . <xₘ (assuming there are no repeated samples). Then, for every i∈[m] and for all x∈[x₁, x₁₊₁] it holds that:

$${h}_{\hat{θ}} ( x ) = {y}_{i} + \frac{{y}_{i + 1} - {y}_{i}}{{x}_{i + 1} - {x}_{i}} ( x - {x}_{i} )$$

In this case, it can be easily shown that for all x∈[x₁, xₘ] we have sign h_{\hat{θ}}(x)=1-NN(S)(x), so training a network with bounded-norm weights (and unbounded width) behaves like nearest neighbor classification over the range covered by the sample. Using this, we show that ReLU networks in this setting are samplers:

Theorem 15. Let [symbol] be the algorithm that takes a sample S and returns a function h such that h(x)=sign (h_{\hat{θ}}(x), for \hat{θ}=R(S). Let [symbol] be some continuous λ-Lipschitz distribution. Then, [symbol] is a sampler for [symbol] . A continuous distribution over [symbol] is defined to be any distribution such that the function ƒ(a)= [symbol] [x≥a] is continuous. Observe that in this case, with probability 1 there are no repeated samples in S, therefore avoiding the case where R(S) is not well-defined.

The above shows that when the size of the network is not limited (i.e., in the overparameterized regime), and use the weights' norm as regularization, the resulting algorithm is a sampler. Observe that using such regularization is necessary for this result. That is, simply choosing some network that fits the data (rather than choosing the network with minimal norm), does not necessarily give a sampler. Indeed, observe that one can construct a ReLU network h_{θ} that outputs a constant value (e.g., 1) for all x∈ [symbol] , outside of infinitesimally small neighborhoods of the points of S, where h_{θ} interpolates the data (namely, h_{θ} is constant with very narrow “spikes” towards the correct labels of the samples in the sampler). Thus, on new points h_{θ} evaluates to 1 with high probability, so it does not behave like a sampler.

Going beyond the one-dimensional case is more challenging, as it requires understanding the high-dimensional geometry of the function returned by R(S). While we defer this case for future work, we note that the analysis of Ongie et al. (See [22]) gives some technical tools for understanding the multivariate version of the above problem. Specifically, [22] shows that solving R(S) is equivalent to minimizing a specific norm in function-space, which controls the complexity of the learned function. Among other things, the authors show that controlling this norm prevents a “spiking” behavior as described above.

### 4.3. Well-Clustered Data and Lipschitz Classes

We now show that under certain clustering assumptions, many learning methods can be teachers. First, we study a simplified case of a distribution supported on a finite set. The following theorem shows that when the hypothesis class shatters the support of the distribution, [symbol] is a teacher with sample complexity Õ(k/ε).

### Theorem 16.

Fix some hypothesis class [symbol] , and let [symbol] be some distribution over [symbol] × [symbol] such that |supp( [symbol] )|=k≤VC( [symbol] ) and the support of [symbol] is shattered. Then, [symbol] is a teacher with sample complexity

$$\tilde{m} ( ε , τ ) = \frac{2 k log ( \frac{2 k}{ε} )}{ε} .$$

Contrast this with Theorem 2, where we show that when VC( [symbol] )=d, ERM is a learner with sample complexity

$$m ( ε ) = \tilde{O} ( \frac{VC ( ℋ )}{{ε}^{2} γ {( 𝒟 )}^{2}} ) .$$

This shows that sampling can be achieved in this case without a dependence on 1/γ², as would be needed in order to get a learner. In fact, Theorem 6 shows that the dependence on 1/γ² in the sample complexity of a learner cannot be avoided.

We proceed to discuss a more general version of Theorem 16 where [symbol] is well-clustered in k
balls of small radius (similar to a Mixture of Gaussians with low variance). In this case, we study L-Lipschitz hypothesis classes, defined as follows:

Definition 17. A hypothesis class [symbol] is L-Lipschitz if for every h∈ [symbol] there exists some ĥ: [symbol] → [symbol] such that ĥ is L-Lipschitz and h(x)=sign ĥ(x) for all x∈ [symbol] .

We note that a large family of learning methods such as bounded norm linear classifiers, kernel Machines, and shallow neural networks with Lipschitz activations (e.g., ReLU) are Lipschitz classes. For learning L-Lipschitz classes, we study the ERM rule with respect to the hinge-loss (over the real-valued output) instead of the zero-one loss. Namely, we define

$$ER {M}_{ℋ}^{hinge} ( S ) = arg {min}_{h ∈ ℋ} {𝔼}_{( x , y )} [ {ℓ}_{h i n g e} ( y , \hat{h} ( x ) ) ] , where {ℓ}_{h i n g e} ( y , \hat{y} = max ( 1 - y \hat{y} , 0 ) .$$

We use the hinge-loss as it is often required that the output of a real-valued hypothesis separates the data with some margin. Indeed, since the zero-one loss is invariant to scale, the L-Lipschitz assumption under the zero-one loss is meaningless, since the hypothesis can always be scaled down to satisfy any Lipschitz bound. So, when the data is well-clustered and the hypothesis class [symbol] is L-Lipschitz

is a teacher with sample complexity

$$\tilde{O} ( \frac{k}{{γ}^{2} ε} ) .$$

While this bound does depend on 1/γ², it still improves the sample complexity of learning derived from Theorem 2.

Theorem 18. For L-Lipschitz class [symbol] , and some λ-Lipschitz distribution [symbol] such that supp( [symbol] )

$$⊆ {⋃}_{i = 1}^{k} B ( {c}_{i} , r ) , where r = \frac{γ}{2 max ( λ , 3 L )} and k \leq VC ( )$$

so the set of balls B(cᵢ,r) can be shattered. Then,

$${ERM}_{ℋ}^{hinge}$$

is a teacher, with sample complexity

$$\tilde{m} ( ε , τ ) = \tilde{O} ( \frac{k log ( 2 k / ε )}{{γ}^{2} ε} ) .$$

### 5. Experiments

To summarize, the above-described portion of the disclosure explained that getting a sampler (and thus a teacher) from a noisy distribution can be more sample efficient than getting a learner. Furthermore, it was illustrated that we can leverage multiple independent teachers to approximate the Bayes optimal classifier either via ensembling at inference time or via distillation on unlabeled data. We now complement the theoretical results with an experimental evaluation, showing the benefit of using distillation when training on noisy data. While in the theoretical setting we studied teachers that are trained on entirely disjoint training sets, in practice it would be more effective to train the teachers on overlapping datasets, as well as training on same dataset with different random initialization.

To get the teachers, we train a ResNet-18 (See [1]) on CIFAR-10 with 20%-fixed and non-uniform label noise (see full details in Appendix D). The teachers achieve 81.3% test accuracy (see Table 1) and behave closely to samplers (see FIGS. 3A-3B) reproducing the results of Nakkiran and Bansal (See [20]). The three methods considered before for using teachers to get learners are compared: 1) Test time Ensembling: 2) Ensemble as distillation teacher and; 3) Random teacher distillation.

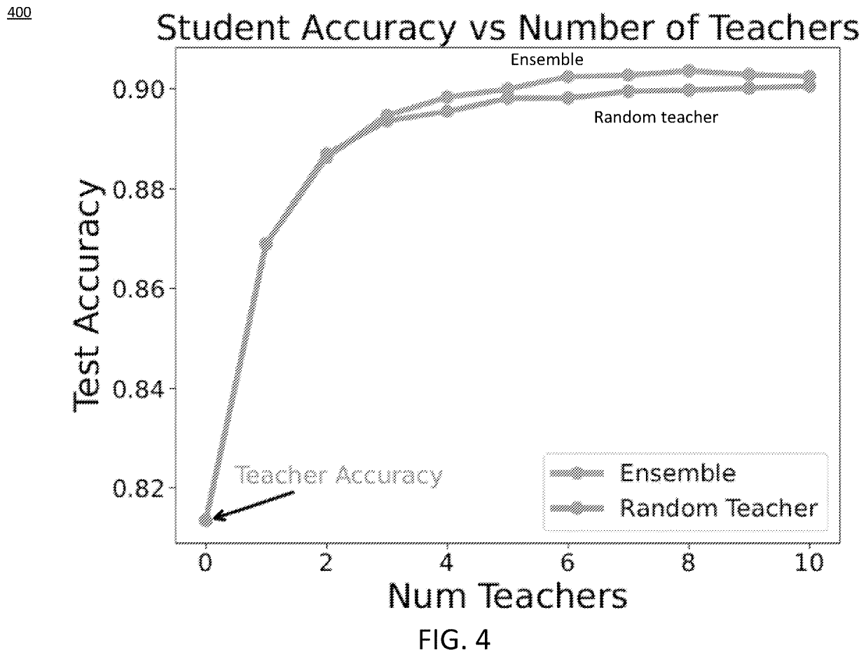

For distillation, a student network is trained on the CIFAR-5m, a large (5-million samples) dataset that resembles the CIFAR-10 dataset Bansal (See [20]), where the labels are provided by the previously trained teachers. The results are shown in Table 1, where the reported accuracies are on the CIFAR-10 test data. Observe that using an ensemble for inference reduces the noise significantly, and achieves test accuracy of 87.8% (versus 81.3% for a single teacher). When applying distillation, both random pseudo-labeling and ensemble pseudo-labeling further increase the test accuracy to about 90%. In addition, we study how the number of teachers affects performance (see FIG. 4). It is observed that both random pseudo-labeling and ensemble majority improve in performance when the number of teachers grow.

### An Example Architecture for Model Training

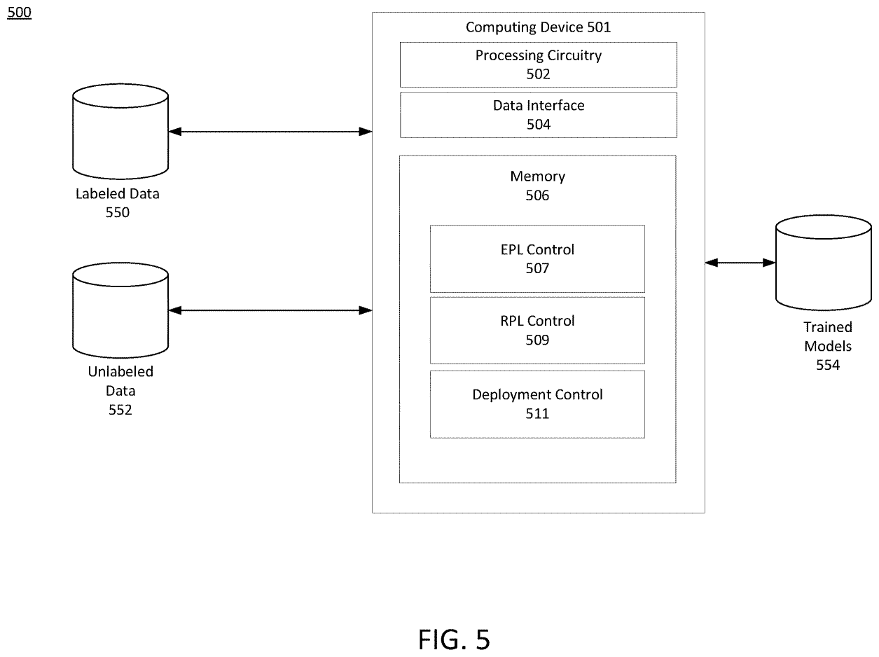

FIG. 5 illustrates a block diagram of an exemplary architecture for model training, in accordance with aspects of the disclosure. In an aspect, the architecture 500 comprises a computing device 500, as well as data storage components 550, 552, 554. The data storage components 550, 552, 554 are shown in FIG. 5 and described herein with respect to the different types of data that are used and/or generated via the architecture 500 for ease of explanation. However, it is understood that in various embodiments any of the data storage components 550, 552, 554 may additionally or alternatively be integrated as part of the computing device 501, such as part of the memory 505 for instance.

The data storage components 550, 552, 554 may be implemented as any suitable number and/or type of storage components, such as non-volatile memory, volatile memory, etc. Moreover, each of the data storage components 550, 552, 554 may be configured to store data in any suitable format, such as e.g. a database architecture, a cloud architecture, a virtual cloud architecture, storage identified with a server or other suitable computing device, etc. When implemented as external and/or separate components, the computing device 501 may be configured to read data from and/or write data to any of the data storage components 550, 552, 554. The computing device 501 and the data storage components 550, 552, 554 may thus be communicatively coupled to one another via any suitable number of communication links for this purpose, which may be any suitable combination of wired and/or wireless links.

The labeled dataset stored in the data storage component 550 may comprise any suitable number of labeled data samples of any suitable type depending upon the particular model that is to be trained. For example, the labeled dataset may comprise a large (e.g. 100, 10,000, a million or more, etc.) images of objects and their classifications (i.e. labels). If the labeled dataset is used in accordance with a vehicle function as further described herein, the labeled dataset may comprise images and corresponding labels of pedestrians, traffic signs, vehicles, etc. The unlabeled dataset stored in the data storage component 552 may likewise comprise any suitable number of unlabeled data samples of any suitable type depending upon the particular model that is to be trained. For example, the unlabeled dataset may also comprise a large (e.g. 100, 10,000, a million or more, etc.) images of objects but without their associated classifications (i.e. labels). Using the previous example, if the unlabeled dataset is used in accordance with a vehicle function, the unlabeled dataset may comprise images of various traffic scenes that include pedestrians, traffic signs, vehicles, etc., but without their corresponding labels.

The computing device 501 as shown and described with respect to FIG. 5 may be identified as a standalone device that may be utilized to perform the aspects as described herein inside or outside of a vehicular environment. Thus, the computing device 501 may perform the functionality as described herein with respect to the in-vehicle processor(s) 102 as discussed above with respect to FIGS. 1 and 2. When implemented as a standalone device, the computing device 501 may be implemented as any suitable computing device such as a personal computer, a server computer, a cloud-based server computer, a mobile device, etc. For example, the computing device 501 may be identified with the one or more other remote computing devices 150, and which may communicate with the vehicle 100 via one or more wireless links 140 (e.g. for deployment of the trained model(s)). When implemented as part of the vehicle 100, the computing device 501 may represent any suitable portion of the safety system 200 as discussed herein. For example, the computing device 501 may be implemented as an ECU or other suitable in-vehicle component configured to communicate with one or more of the components of the safety system 200 as discussed herein.

In any event, the computing device 501 is configured to perform the various functions as discussed herein to perform model training, deployment, and/or use (e.g. at inference time) of the trained and deployed models in accordance with any suitable application for which the models have been trained. In this context, it is noted that the computing device used to perform the training, deployment, and use of the trained and deployed models may be the same computing device or different computing devices. For instance, the models may be trained by a computing device 501 that is external to the vehicle 100, and then subsequently deployed and used by the vehicle safety system 200. To provide another example, the computing device 501 may comprise part of the safety system 200, as noted above, and may perform one or more (or all) of the steps for model training, deployment, and use as part of the operation of the vehicle 100. Furthermore, although at times referred to herein in a singular sense, the embodiments include the training, deployment, and/or use of any suitable number of models, which may support any suitable number and/or type of different functions and/or applications.

When implemented as part of a vehicle, the computing device 501 may be configured to receive, for example, any suitable type of data that may be used in accordance with the deployed trained model(s) to enable a vehicle function. The type of data received in this manner is a function of the type of application for which the model has been trained. For example, the model may be trained to perform, as the vehicle function, any suitable type of classification techniques. This may include object classification for example, which may be particularly useful in the context of autonomous and/or ADAS vehicle systems. Continuing this example, the computing device 501 may receive sensor data from any suitable number and/or type of sensor sources implemented via the safety system 200, such as images acquired via the image acquisition devices 104, data acquired via IMU sensors such as compasses, gyroscopes, accelerometers, etc., ultrasonic sensors, infrared sensors, thermal sensors, digital compasses, RADAR, LIDAR, optical sensors, etc.

Although described herein in the context of performing a vehicle function, the embodiments described herein are not limited in this regard, and the training, deployment, and use of the trained models as discussed herein may be performed in accordance with any suitable application for which models are trained. To do so, the computing device 501 may include processing circuitry 502, a data interface 504, and a memory 506. The components shown in FIG. 5 are provided for ease of explanation, and aspects include the computing device 501 implementing additional, less, or alternative components as those shown in FIG. 5.

In various aspects, the processing circuitry 502 may be configured as any suitable number and/or type of computer processors, which may function to control the computing device 501 and/or components of the computing device 501. The processing circuitry 502 may be identified with one or more processors (or suitable portions thereof) implemented by the computing device 501. For example, the processing circuitry 502 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc. In an embodiment, the processing circuitry 502 may be identified with the in-vehicle processor(s) 102 as described herein with respect to the safety system 200, e.g. when the computing device 501 is implemented as part of an in-vehicle component and/or part of the safety system 200.

In any event, aspects include the processing circuitry 502 being configured to carry out instructions to perform arithmetical, logical, and/or input/output (I/O) operations, and/or to control the operation of one or more components of computing device 501 to perform various functions associated with the aspects as described herein. For example, the processing circuitry 502 may include one or more microprocessor cores, memory registers, buffers, clocks, etc., and may generate electronic control signals associated with the components of the computing device 502 to control and/or modify the operation of these components. For example, aspects include the processing circuitry 502 communicating with and/or controlling functions associated with the data interface 504 and/or the memory 506. The processing circuitry 502 may additionally perform various operations as discussed herein with reference to the one or more processors of the safety system 200 identified with the vehicle 100.

In an aspect, the data interface 504 may be implemented as any suitable number and/or type of components configured to transmit and/or receive data and/or wireless signals in accordance with any suitable number and/or type of communication protocols. The data interface 504 may include any suitable type of components to facilitate this functionality, including components associated with known transceiver, transmitter, and/or receiver operation, configurations, and implementations. The data interface 504 may include components typically identified with wired and/or wireless data interfaces, such as e.g. an RF front end, antennas, ports, power amplifiers (PAs), RF filters, mixers, local oscillators (LOs), low noise amplifiers (LNAs), upconverters, downconverters, channel tuners, buffers, drivers, etc.

Regardless of the particular implementation, the data interface 504 may include one or more components configured to transmit data that is written to one or more of the storage components 550, 552, 554 and/or to read and receive data from the one or more of the storage components 550, 552, 554 as discussed herein, which may be used to train, deploy, and/or use trained models.

In an aspect, the memory 506 stores data and/or instructions such that, when the instructions are executed by the processing circuitry 502, cause the computing device 501 to perform various functions as described herein, such as those described above, for example. The memory 506 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 506 may be non-removable, removable, or a combination of both. For example, the memory 506 may be implemented as a non-transitory computer readable medium storing one or more executable instructions such as, for example, logic, algorithms, code, etc.

As further discussed below, the instructions, logic, code, etc., stored in the memory 506 are represented by the various modules as shown in FIG. 5, which may enable the aspects disclosed herein to be functionally realized. Alternatively, if the aspects described herein are implemented via hardware, the modules shown in FIG. 5 associated with the memory 506 may include instructions and/or code to facilitate control and/or monitor the operation of such hardware components. In other words, the modules shown in FIG. 5 are provided for ease of explanation regarding the functional association between hardware and software components. Thus, aspects include the processing circuitry 502 executing the instructions stored in these respective modules in conjunction with one or more hardware components to perform the various functions associated with the aspects as further discussed herein.

In an aspect, the executable instructions stored in the Ensemble-Pseudo-Labeling (EPL) control module 507 may facilitate, in conjunction with execution via the processing circuitry 502, the computing device 501 executing an EPL algorithm to generate trained models. To do so, it is noted that the various “samplers,” “learners,” and teachers” described herein may be implemented as trained models. These models may be trained in accordance with any suitable type of training algorithm, such as a machine learning training algorithm which may include an artificial neural network, a convolutional neural network, etc. For instance, the algorithms used to generate the trained models may comprise, for instance, Nearest Neighbor algorithms, Naive Bayes, Decision Trees, Linear Regression, Support Vector Machines (SVM), Neural Networks, etc.

Thus, as an initial step, which was described above in Section 3.2, an ensemble of teachers may be generated via the execution of the EPL algorithm, or may be previously generated via another suitable algorithm. Thus, an ensemble of teachers may represent a set of machine learning trained models that meet a predetermined set of conditions, such as those described above in Definition 7, for example. To provide an illustrative example, the predetermined set of machine learning trained models, which constitute the ensemble of teachers as discussed herein, function to output a classifier from unlabeled data that approximates the Bayes optimal predictor. Approximation in this context means that the probabilities of classifications generated by the predetermined set of machine learning trained models are within a threshold probability compared to the output of the Bayes optimal predictor with respect to the same dataset. As noted above, predetermined set of machine learning trained models may produce outputs that replicate a noise distribution of samples in the labeled dataset, which the embodiments address, as noted herein.

Thus, the EPL algorithm functions to generate and/or utilize a set of predetermined machine learning trained models that constitute the “teachers” as discussed herein by identifying machine learning models that meet a set of predefined conditions. These predefined conditions are described above in Section 2.2 by way of example and not limitation. That is, in order to qualify as one of the ensemble members used for the EPL algorithm, each machine learning trained model in the predetermined set of trained models should meet these conditions.

For instance, a first condition may include a Bayes optimal probability distribution associated with the labeled dataset and a probability distribution of output data generated via a machine learning trained model being within a threshold value of one another. An additional or alternative second condition may comprise a probability mass of a subset of margin samples from output data generated via a candidate machine learning trained model being less than a threshold value.

Thus, the ensemble of teachers constitute a set of predetermined machine learning trained models that are generated (via the EPL algorithm or another suitable algorithm) using the labeled data stored in the data storage component 550. This ensemble of teachers, i.e. the set of predetermined machine learning models, are thus selected based upon each one meeting one or more conditions, e.g. those described above. Once the predetermined set of machine learning trained models are selected and/or generated, the EPL algorithm functions to generate a machine learning trained model using the unlabeled data from the storage component 552.

Again, this results in the training of a new classifier to imitate the ensemble, as discussed above with respect to Section 3.2. The EPL algorithm performs this training as part of a knowledge distillation process by applying each one of the predetermined set of machine learning trained models to an unlabeled sample retrieved from the unlabeled dataset, which may constitute one sample from hundreds, thousands, millions, etc. Each one of the predetermined set of machine learning trained models then outputs a labeled (i.e. classified) sample, which may represent a probability value for instance. The output of each of the predetermined set of machine learning trained models are then averaged together to provide an output classifier, which represents the output of the trained model, i.e. the “student” as discussed herein.

Once trained in this manner to leverage knowledge distillation, the trained “student” model is subsequently deployed and used as noted herein. In an aspect, the executable instructions stored in the deployment control module 511 may facilitate, in conjunction with execution via the processing circuitry 502, the computing device 501 deploying the trained model to a suitable computing system in accordance with a particular application. Again, by way of example and not limitation, this may include the trained model being deployed as part of a safety system or other suitable components of a vehicle (e.g. an autonomous or semi-autonomous vehicle), which may utilize received sensor data or other suitable data to enable a vehicle function. The vehicle function may comprise object classification or any other suitable type of function based upon the functionality of the trained model and the expected input and output data. The deployment control module 511 may thus facilitate the deployment, when necessary, of the trained model from the computing device 501 to another computing system in which the trained model will be implemented. This may be performed, for instance, via the data interface 504 by transmitting and/or transferring the trained model to the appropriate computing system.

As noted above, the use of the EPL algorithm advantageously moves the computational burden from inference time to training time, although the labeling of each sample still remains a computational burden. Thus, in an embodiment, the executable instructions stored in the Random-Pseudo-Labeling (RPL) model 509 may facilitate, in conjunction with execution via the processing circuitry 502, the computing device 501 generating a trained model by leveraging a randomly selected ensemble approach.

It is noted that the trained models generated via the RPL algorithm may be used in accordance with the same applications (e.g. deployment for vehicle functions) as discussed above with respect to the EPL algorithms, and therefore only differences between these two algorithms are further discussed below for purposes of brevity. For example, the EPL and the RPL algorithms both leverage the use of an ensemble, i.e. a predetermined set of trained models that meet one or more predefined conditions, examples of which were described above. Moreover, both the EPL and the RPL algorithms may be implemented to generate a trained model using a knowledge distillation process, which may then be deployed for use in a computing device such as a vehicle to perform vehicle functions, e.g. object classification.

However, in contrast to the EPL algorithm, the RPL algorithm generates a machine learning trained model by applying, for each sample in the unlabeled dataset, a randomly selected one of the predetermined set of trained models. That is, instead of applying each of the predetermined set of trained models to each unlabeled sample, one of the predetermined set of trained models is randomly selected and applied to each unlabeled sample to generate labeled data. This is repeated for any suitable number of unlabeled samples, and results in a much less computationally intensive training process compared to the EPL algorithm.

As discussed in further detail in Section 3.3 above, the random use of one of the ensemble members allows for the labeled data generated by the trained (i.e. “student”) model in this way to have a reduced noise distribution. Specifically, the noise distribution of the labeled data output by the trained model is less than the noise distribution of samples in the labeled dataset, which again is replicated by the predetermined set of trained models as noted above. In other words, the use of the RPL algorithm in this manner ensures that the noise is not sampled and passed to the output of the trained model, as was the case for the predetermined set of trained models due to their sampling effect.

Furthermore, because the distillation is performed in this manner from a random selection among an ensemble of teachers, the resulting trained model yields a low error with respect to the Bayes optimal. In other words, the model trained in accordance with the RPL algorithm advantageously provides a trained model that generates labeled data from unlabeled data within a predetermined threshold of Bayes class-probabilities generated via a Bayes optimal classifier. Embodiments include, for both the EPL and RPL algorithms, defining a predetermined threshold that is met upon generating the trained model, such that accuracy of classifications is ensured.

### An Example Process Flow

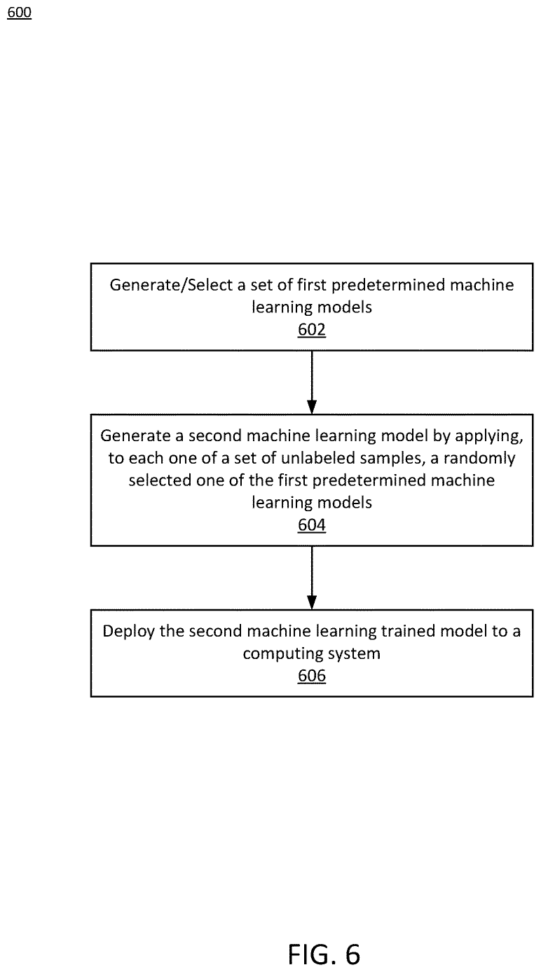

FIG. 6. illustrates an example process flow, in accordance with one or more aspects of the present disclosure. The functionality associated with the blocks as discussed herein with reference to FIG. 6 may be executed, for instance, via processing circuitry identified with the vehicle 100, the safety system 200, and/or the computing device 501. This may include, for example, the one or more processors 102, one or more of the processors 214A, 214B, 216, 218, etc., executing instructions stored in a suitable memory (e.g. the one or more memories 202), the processing circuitry 502, etc. Again, the processing circuitry may implement the aspects as described herein as part of an ADAS and/or AV system of the vehicle 100, or may be executed independently of such systems to implement the aspects as described herein.

The process flow 600 may begin generating and/or selecting (block 602) a set of first machine learning trained models using a labeled dataset comprising labeled data. The set of first machine learning trained models may, for example, comprise the ensemble of “teachers” as discussed herein, and be generated and/or selected based upon machine learning models that meet predefined conditions.

The process flow 600 may include generating (block 604) a second machine learning trained model by applying, to each one of a set of samples in an unlabeled dataset, a randomly selected one of the set of first machine learning trained models. This may include, for instance, generating a trained “student” model as discussed herein in accordance with the RPL algorithm.

The process flow 600 may include deploying (block 606) the second machine learning trained model to a suitable computing system. This may include, for example, deploying the second machine learning trained model to the safety system 200 or other suitable computing system, e.g. one identified with a vehicle. The second machine learning trained model, once deployed, may be utilized to perform a vehicle function such as object classification for example.

### EXAMPLES

The following examples pertain to further aspects.

An example (e.g. example 1) relates to a non-transitory computer-readable medium. The non-transitory computer-readable medium has instructions stored thereon that, when executed by processing circuitry, cause the processing circuitry to: generate a set of first machine learning trained models using a labeled dataset comprising labeled data; and generate a second machine learning trained model by applying, to each one of a plurality of samples in an unlabeled dataset, a randomly selected one of the set of first machine learning trained models, wherein the second machine learning trained model, upon being deployed as part of a safety system of a vehicle, is used in accordance with received sensor data to enable a vehicle function.

Another (e.g. example 2) relates to a previously-described example (e.g. example 1), wherein the vehicle comprises an autonomous vehicle (AV), and wherein the vehicle function comprises object classification

Another example (e.g. example 3) relates to a previously-described example (e.g. one or more of examples 1-2), wherein the generation of the second machine learning trained model comprises part of a knowledge distillation process.

Another example (e.g. example 4) relates to a previously-described example (e.g. one or more of examples 1-3), wherein the first set of machine learning trained models produce outputs that replicate a noise distribution of samples in the labeled dataset.

Another example (e.g. example 5) relates to a previously-described example (e.g. one or more of examples 1-4), wherein the second machine learning trained model generates labeled data from the unlabeled dataset having a noise distribution that is less than the noise distribution of samples in the labeled dataset that is replicated by the first set of machine learning trained models

Another example (e.g. example 6) relates to a previously-described example (e.g. one or more of examples 1-5), wherein the second machine learning trained model generates labeled data within a predetermined threshold of Bayes class-probabilities generated via a Bayes optimal classifier.

Another example (e.g. example 7) relates to a previously-described example (e.g. one or more of examples 1-6), wherein the set of first machine learning trained models meet a first condition in which a Bayes optimal probability distribution associated with the labeled dataset and a probability distribution of output data generated via the set of first machine learning trained models are within a first threshold value of one another.

Another example (e.g. example 8) relates to a previously-described example (e.g. one or more of examples 1-7), wherein the set of first machine learning trained models meet a second condition in which a probability mass of a subset of margin samples from the output data generated via the set of first machine learning trained models is less than a second threshold value.

An example (e.g. example 9) is directed to a vehicle. The vehicle comprise: a memory configured to store instructions; and processing circuitry that is part of a safety system of the vehicle, the processing circuitry being configured to execute the instructions stored in the memory to cause the vehicle to: generate a set of first machine learning trained models using a labeled dataset comprising labeled data; and generate a second machine learning trained model by applying, to each one of a plurality of samples in an unlabeled dataset, a randomly selected one of the set of first machine learning trained models, wherein the second machine learning trained model, upon being deployed as part of the safety system, is used in accordance with received sensor data to enable a vehicle function.

Another example (e.g. example 10) relates to a previously-described example (e.g. example 9), wherein the vehicle comprises an autonomous vehicle (AV), and wherein the vehicle function comprises object classification.

Another example (e.g. example 11) relates to a previously-described example (e.g. one or more of examples 9-10), wherein the processing circuitry is configured to generate the second machine learning trained model as part of a knowledge distillation process.

Another example (e.g. example 12) relates to a previously-described example (e.g. one or more of examples 9-11), the first set of machine learning trained models produce outputs that replicate a noise distribution of samples in the labeled dataset.

Another example (e.g. example 13) relates to a previously-described example (e.g. one or more of examples 9-12), wherein the second machine learning trained model generates labeled data from the unlabeled dataset having a noise distribution that is less than the noise distribution of samples in the labeled dataset that is replicated by the first set of machine learning trained models.

Another example (e.g. example 14) relates to a previously-described example (e.g. one or more of examples 9-13), wherein the second machine learning trained model generates labeled data within a predetermined threshold of Bayes class-probabilities generated via a Bayes optimal classifier.

Another example (e.g. example 15) relates to a previously-described example (e.g. one or more of examples 9-14), wherein the set of first machine learning trained models meet a first condition in which a Bayes optimal probability distribution associated with the labeled dataset and a probability distribution of output data generated via the set of first machine learning trained models are within a first threshold value of one another.

Another example (e.g. example 16) relates to a previously-described example (e.g. one or more of examples 9-15), wherein the set of first machine learning trained models meet a second condition in which a probability mass of a subset of margin samples from the output data generated via the set of first machine learning trained models is less than a second threshold value.

An example (e.g. example 17) is directed to a method. The method comprises generating a set of first machine learning trained models using a labeled dataset comprising labeled data; generating a second machine learning trained model by applying, to each one of a plurality of samples in an unlabeled dataset, a randomly selected one of the set of first machine learning trained models; deploying the second machine learning trained model to a safety system of a vehicle; and using the second machine learning trained model in accordance with received sensor data to enable a vehicle function.

Another example (e.g. example 18) relates to a previously-described example (e.g. example 17), wherein the vehicle comprises an autonomous vehicle (AV), and wherein the vehicle function comprises object classification.

Another example (e.g. example 19) relates to a previously-described example (e.g. one or more of examples 17-18), wherein the act of generating the second machine learning trained model comprises generating the second machine learning trained model as part of a knowledge distillation process.

Another example (e.g. example 20) relates to a previously-described example (e.g. one or more of examples 17-19), wherein the first set of machine learning trained models produce outputs that replicate a noise distribution of samples in the labeled dataset.

Another example (e.g. example 21) relates to a previously-described example (e.g. one or more of examples 17-20), wherein the second machine learning trained model generates labeled data from the unlabeled dataset having a noise distribution that is less than the noise distribution of samples in the labeled dataset that is replicated by the first set of machine learning trained models.

Another example (e.g. example 22) relates to a previously-described example (e.g. one or more of examples 17-21), wherein the second machine learning trained model generates labeled data within a predetermined threshold of Bayes class-probabilities generated via a Bayes optimal classifier.

Another example (e.g. example 23) relates to a previously-described example (e.g. one or more of examples 17-22), wherein the set of first machine learning trained models meet a first condition in which a Bayes optimal probability distribution associated with the labeled dataset and a probability distribution of output data generated via the set of first machine learning trained models are within a first threshold value of one another.

Another example (e.g. example 24) relates to a previously-described example (e.g. one or more of examples 17-23), wherein the set of first machine learning trained models meet a second condition in which a probability mass of a subset of margin samples from the output data generated via the set of first machine learning trained models is less than a second threshold value.

An apparatus as shown and described.

A method as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCES

The following references are cited throughout this disclosure as applicable to provide additional clarity, particularly with regards to terminology. These citations are made by way of example and ease of explanation and not by way of limitation.

Citations to the following references are made throughout the application using a matching bracketed number, e.g., [1].
[1] Dana Angluin and Philip Laird. Learning from noisy examples. Machine Learning, 2(4): 343-370, 1988.
[2] Peter L Bartlett, Philip M Long, G'abor Lugosi, and Alexander Tsigler. Benign overfitting in linear regression. Proceedings of the National Academy of Sciences, 117(48): 30063-30070, 2020.
[3] Ruth Ben-Yashar and Jacob Paroush. A nonasymptotic condorcet jury theorem. Social Choice and Welfare, 17(2): 189-199, 2000.
[4] Daniel Berend and Luba Sapir. Monotonicity in condorcet jury theorem. Social Choice and Welfare, 24(1): 83-92, 2005.
[5] Avrim Blum, Adam Kalai, and Hal Wasserman. Noise-tolerant learning, the parity problem, and the statistical query model. Journal of the ACM (JACM), 50(4): 506-519, 2003.
[6] Ting Chen, Simon Kornblith, Kevin Swersky, Mohammad Norouzi, and Geoffrey E. Hinton. Big self-supervised models are strong semi-supervised learners. CoRR, abs/2006.10029, 2020. URL https://arxiv.org/abs/2006.10029.
[7] Bin Dong, Jikai Hou, Yiping Lu, and Zhihua Zhang. Distillation early stopping? Harvesting dark knowledge utilizing anisotropic information retrieval for overparameterized neural network. arXiv preprint arXiv: 1910.01255, 2019.
[8] Spencer Frei, Difan Zou, Zixiang Chen, and Quanquan Gu. Self-training converts weak learners to strong learners in mixture models. arXiv preprint arXiv: 2106.13805, 2021.
[9] Beno\hat{ }ιt Fr'enay and Michel Verleysen. Classification in the presence of label noise: a survey. IEEE transactions on neural networks and learning systems, 25(5): 845-869, 2013.
[10] Tommaso Furlanello, Zachary C. Lipton, Michael Tschannen, Laurent Itti, and Anima Anandkumar. Born again neural networks, 2018.
[11] Jianping Gou, Baosheng Yu, Stephen J Maybank, and Dacheng Tao. Knowledge distillation: A survey. International Journal of Computer Vision, 129(6): 1789-1819, 2021.
[12] Christian Haase-Schutz, Rainer Stal, Heinz Hertlein, and Bernhard Sick. Iterative label improvement: Robust training by confidence based filtering and dataset partitioning. In 2020 25th International Conference on Pattern Recognition (ICPR), pages 9483-9490. IEEE, 2021.
[13] Kaiming He, Xiangyu Zhang, Shaoqing Ren, and Jian Sun. Deep residual learning for image recognition. CoRR, abs/1512.03385, 2015. URL http://arxiv.org/abs/1512.03385.
[14] Geoffrey Hinton, Oriol Vinyals, and Jeff Dean. Distilling the knowledge in a neural network, 2015.
[15] Michael Kearns. Efficient noise-tolerant learning from statistical queries. Journal of the ACM (JACM), 45(6): 983-1006, 1998.
[16] Alex Krizhevsky, Geoffrey Hinton, et al. Learning multiple layers of features from tiny images. CoRR, 2009.
[17] David Lopez-Paz, L'eon Bottou, Bernhard Scholkopf, and Vladimir Vapnik. Unifying distillation and privileged information. arXiv preprint arXiv: 1511.03643, 2015.
[18] Aditya Krishna Menon, Ankit Singh Rawat, Sashank J. Reddi, Seungyeon Kim, and Sanjiv Kumar. Why distillation helps: a statistical perspective. CoRR, abs/2005.10419, 2020. URL https://arxiv.org/abs/2005.10419.
[19] Hossein Mobahi, Mehrdad Farajtabar, and Peter Bartlett. Self-distillation amplifies regularization in hilbert space. Advances in Neural Information Processing Systems, 33:3351-3361, 2020.
[20] Preetum Nakkiran and Yamini Bansal. Distributional generalization: A new kind of generalization. arXiv preprint arXiv: 2009.08092, 2020.
[21] Preetum Nakkiran, Behnam Neyshabur, and Hanie Sedghi. The deep bootstrap: Good online learners are good offline generalizers. CoRR, abs/2010.08127, 2020. URL https://arxiv.org/abs/2010.08127.
[22] Greg Ongie, RebeccaWillett, Daniel Soudry, and Nathan Srebro. A function space view of bounded norm infinite width relu nets: The multivariate case. arXiv preprint arXiv: 1910.01635, 2019.
[23] Hieu Pham, Qizhe Xie, Zihang Dai, and Quoc V. Le. Meta pseudo labels. CoRR, abs/2003.10580, 2020. URL https://arxiv.org/abs/2003.10580.
[24] Pedro Savarese, Itay Evron, Daniel Soudry, and Nathan Srebro. How do infinite width bounded norm networks look in function space? In Conference on Learning Theory, pages 2667-2690. PMLR, 2019.
[25] Shai Shalev-Shwartz and Shai Ben-David. Understanding machine learning: From theory to algorithms. Cambridge university press, 2014.
[26] Hwanjun Song, Minseok Kim, Dongmin Park, Yooju Shin, and Jae-Gil Lee. Learning from noisy labels with deep neural networks: A survey. arXiv preprint arXiv: 2007.08199, 2020.
[27] Siqi Sun, Yu Cheng, Zhe Gan, and Jingjing Liu. Patient knowledge distillation for BERT model compression. CoRR, abs/1908.09355, 2019. URL http://arxiv.org/abs/1908.09355.
[28] Colin Wei, Kendrick Shen, Yining Chen, and Tengyu Ma. Theoretical analysis of self-training with deep networks on unlabeled data. arXiv preprint arXiv: 2010.03622, 2020.
[29] Qizhe Xie, Eduard H. Hovy, Minh-Thang Luong, and Quoc V. Le. Self-training with noisy student improves imagenet classification. CoRR, abs/1911.04252, 2019. URL http://arxiv.org/abs/1911.04252.
[30] I. Zeki Yalniz, Herv′e J'egou, Kan Chen, Manohar Paluri, and Dhruv Mahajan. Billion-scale semisupervised learning for image classification, 2019.
[31] Chiyuan Zhang, Samy Bengio, Moritz Hardt, Benjamin Recht, and Oriol Vinyals. Understanding deep learning requires rethinking generalization. CoRR, abs/1611.03530, 2016. URL http://arxiv.org/abs/1611.03530.
[32] Shuai Zhang, Meng Wang, Sijia Liu, Pin-Yu Chen, and Jinjun Xiong. How does unlabeled data improve generalization in self-training? a one-hidden-layer theoretical analysis. arXiv preprint arXiv: 2201.08514, 2022.

### APPENDIX

The following Appendix includes additional details and proofs regarding the various Theorems and Definitions as discussed herein, and also provide further details regarding the experimental results. The following Appendix is considered an extension of this paragraph.

### Appendix A. Proofs for Section 2

### Proof of Lemma 3.

For every x denote γ(x)= [symbol] [y=h*(x)|x]− [symbol] [y≠h*(x)|x], and since h* is the Bayes optimal predictor it holds that γ(x)≥0. Observe the following:

$$\begin{matrix}{L}_{𝒟} ( h ) = {𝔼}_{x ∼ 𝒟} [ ℙ [ y \neq h ( x ) \vert x ] ] \\ = {𝔼}_{x ∼ 𝒟} [ ℙ [ y \neq h ( x ) \vert x ] \cdot 1 \{ h ( x ) = h * ( x ) \} ] \\ + {𝔼}_{x ∼ 𝒟} [ ℙ [ y \neq h ( x ) \vert x ] \cdot 1 \{ h ( x ) \neq h * ( x ) \} ] \\ = {𝔼}_{x ∼ 𝒟} [ ℙ [ y \neq h * ( x ) \vert x ] \cdot 1 \{ h ( x ) = h * ( x ) \} ] \\ + {𝔼}_{x ∼ 𝒟} [ ℙ [ y = h * ( x ) \vert x ] \cdot 1 \{ h ( x ) \neq h * ( x ) \} ] \\ = {𝔼}_{x ∼ 𝒟} [ ℙ [ y \neq h * ( x ) \vert x ] \cdot 1 \{ h ( x ) = h * ( x ) \} + \\ 1 \{ h ( x ) \neq h * ( x ) \} ) ] \\ + {𝔼}_{x ∼ 𝒟} [ γ ( x ) \cdot 1 \{ h ( x ) \neq h * ( x ) \} ] \\ = {L}_{𝒟} ( h \text{*)} + {𝔼}_{x ∼ D} [ γ ( x ) \cdot 1 \{ h ( x ) \neq h * ( x ) \} ]\end{matrix} \qquad ( 2 )$$

Now, notice that we have:

$$\begin{matrix}{𝔼}_{x ∼ 𝒟} [ γ ( x ) \cdot 1 \{ h ( x ) \neq h * ( x ) \} ] \geq {𝔼}_{x ∼ 𝒟} [ γ ( x ) \cdot 1 \{ h ( x ) \neq h * ( x ) \} \cdot \\ 1 \{ γ ( x ) \geq {γ}_{δ} ( 𝒟 ) \} ] \\ \geq {γ}_{δ} ( 𝒟 ) {ℙ}_{𝒟} ( A ⋂ B )\end{matrix} \qquad ( 3 )$$

where A denotes the event where h(x)≠h*(x) and B denotes the event where γ(x)≥γ_{δ}( [symbol] ). By definition of the loss we have [symbol] (A)= [symbol] (h), and by definition of the margin we have [symbol] (B)≥1−δ. Therefore, we have:

$${ℙ}_{𝒟} ( A ⋂ B ) = {ℙ}_{𝒟} ( A ) + {ℙ}_{𝒟} ( B ) - {ℙ}_{𝒟} ( A ⋃ B ) \geq {L}_{𝒟} * ( h ) + ( 1 - δ ) - 1 = {L}_{D} * ( h ) - δ \qquad ( 4 )$$

Now, combining Eq. (2), (3) and (4), together with the fact that [symbol] (h)≤ [symbol] (h*)+ε, we get:

$${γ}_{δ} ( 𝒟 ) ( {L}_{𝒟} * ( h ) - δ ) + {L}_{𝒟} ( h \text{*)} \leq {L}_{𝒟} ( h ) \leq {L}_{𝒟} ( h \text{*)} + ε$$

and so the required follows.

### Proof of Theorem 2.

Fix some ε∈(0, 1) and let

$${ε}^{′} \frac{εγ ( 𝒟 )}{2} and {δ}^{′} = \frac{ε}{2} .$$

By the Fundamental Theorem of Statistical Learning (see Shalev-Shwartz and Ben-David (2014)), there exists some universal constant C s.t. taking

$$m = C \frac{VC ( ) + log ( 1 / {δ}^{′} )}{{( {ε}^{′} )}^{2}}$$

we get that w.p. at least 1−δ′ over sampling S˜ [symbol] ^{m} it holds that:

$${L}_{𝒟} ( ( S ) ) \leq {L}_{𝒟} ( h ) + {ε}^{′} = {L}_{𝒟} ( {f}_{𝒟}^{*} ) + {ε}^{′}$$

where we use the fact that

$${f}_{𝒟}^{*} ∈$$

is the Bayes optimal of [symbol] . Now, from Lemma 3 it holds that, w.p. at least 1−δ′ it holds that (note that γ( [symbol] )=γ₀( [symbol] )),

$${L}_{𝒟} * ( ( S ) ) \leq \frac{{ε}^{′}}{γ ( 𝒟 )}$$

So, we get that:

$${𝔼}_{S ∼ {𝒟}^{m}} {L}_{𝒟} * ( ( S ) ) \leq \frac{{ε}^{′}}{γ ( 𝒟 )} + {δ}^{′} = ε$$

### Proof of Lemma 5.

Let the event E={(x, y)|y≠ƒ*(x)}, then,

$$\begin{matrix}\vert η ( 𝒟 ) - {𝔼}_{S ∼ {𝒟}^{m}} {L}_{𝒟} * ( ( S ) ) \vert = \vert {ℙ}_{x , y ∼ 𝒟} [ y \neq f * ( x ) ] - {ℙ}_{{x ∼ {𝒟}_{x}}_{S ∼ {𝒟}^{m}}} [ ( S ) ( x ) \neq f * ( x ) ] \vert = \\ = \vert 𝒟 ( E ) - ( {𝒟}^{m} ) ( E ) \vert \leq {sup}_{E} \vert 𝒟 ( E ) - \\ ( {𝒟}^{m} ) ( E ) \vert = \\ = TV ( 𝒟 , ( {𝒟}^{m} ) ) = ε\end{matrix}$$

### Proof of Theorem 6.

We follow a proof similar to Chapter 28.2.1 of Shalev-Shwartz and Ben-David (2014). Let

$$γ = \sqrt{\frac{log ( 4 / 3 )}{2 M}} .$$

For every b∈{±1}, in [symbol] _{b} be the distributions concentrated on a single example x∈ [symbol] , with label,

$$y ∼ {P}_{b} ( y ) = Bernoulli ( \frac{1 + b γ}{2} ) = \{ \begin{matrix}\frac{1 + b γ}{2} & if y = 1 \\ \frac{1 - b γ}{2} & if y = - 1\end{matrix}$$

Take [symbol] ={ [symbol] ₊, [symbol] ₋}. Observe that the algorithm [symbol] that takes a single sample (x, y₀) and outputs y₀ is a sampler for every [symbol] ∈ [symbol] .

Let y∈{±1}^{m} be the sequence of labels observed by the algorithm [symbol] , and denote by [symbol] (y)∈{±1} the label that [symbol] outputs for x when observing the sequence of labels y. Note, that [symbol] * will be a constant distribution concentrated on (x, b). Therefore, we have:

$${𝔼}_{S ∼ {𝒟}_{b}^{m}} {L}_{𝒟 *} ( 𝒜 ( S ) ) = {𝔼}_{S ∼ {𝒟}_{b}^{m}} 1 \{ 𝒜 ( S ) ( x ) \neq b \} = {𝔼}_{y ∼ {P}_{b}^{m}} 1 \{ 𝒜 ( y ) \neq b \}$$

$$Denote {N}_{+} := \{ y ∈ {\{ \pm 1 \}}^{m} : {\sum }_{i} {y}_{i} \geq 0 \} and {N}_{-} = {\{ \pm 1 \}}^{m} \backslash {N}_{+} . Then :$$

$${𝔼}_{y ∼ {P}_{+}^{m}} 1 \{ 𝒜 ( y ) = - 1 \} + {𝔼}_{y ∼ {P}_{-}^{m}} 1 \{ 𝒜 ( y ) = 1 \} = {\sum }_{y} {P}_{+} ( y ) 1 \{ 𝒜 ( y ) = - 1 \} + {P}_{-} ( y ) 1 \{ 𝒜 ( y ) = 1 \} = {\sum }_{y ∈ {N}_{+}} {P}_{+} ( y ) 1 \{ 𝒜 ( y ) = - 1 \} + {P}_{-} ( y ) 1 \{ 𝒜 ( y ) = 1 \} + {\sum }_{y ∈ {N}_{-}} {P}_{+} ( y ) 1 \{ 𝒜 ( y ) = - 1 \} + {P}_{-} ( y ) 1 \{ 𝒜 ( y ) = 1 \} \geq {\sum }_{y ∈ {N}_{+}} {P}_{-} ( y ) + {\sum }_{y ∈ {N}_{-}} {P}_{+} ( y ) \geq \frac{1}{2} ( 1 - \sqrt{1 - exp ( - 2 m {γ}^{2}} )$$

where the last inequality follows from Lemma B.11 in Shalev-Shwartz and Ben-David (2014). So, if

$$m < \frac{log ( 4 / 3 )}{2 {γ}^{2}} = M we get :$$

$${𝔼}_{b} {𝔼}_{S ∼ {𝒟}_{b}^{m}} {L}_{𝒟 *} ( 𝒜 ( S ) ) = \frac{1}{2} ( {𝔼}_{y ∼ {P}_{+}^{m}} 1 \{ 𝒜 ( y ) = - 1 \} + {𝔼}_{y ∼ {P}_{-}^{m}} 1 \{ 𝒜 ( y ) = - 1 \} > \frac{1}{8}$$

and we get there exists [symbol] ∈ [symbol] s.t. if m<M then

$${𝔼}_{S ∼ {𝒟}^{m}} {L}_{𝒟 *} ( 𝒜 ( S ) ) > \frac{1}{8} .$$

### Proof of Theorem 8.

To see property 1. of Definition 7, we show that if two distributions over (x, y) are close in total variation, then the Bayes optimal classifier for both has to be similar. That is,

$$TV ( 𝒟 , {𝒟}^{′} ) < ε ⇒ {ℙ}_{x ∼ 𝒟} [ {f}_{𝒟}^{*} ( x ) \neq {f}_{{𝒟}^{′}}^{*} ( x ) ] \leq ε / γ$$

$$Note , for x ∼ {𝒟}_{χ} we have {y}_{x} \text{=:} {f}_{𝒟}^{*} ( x ) \neq {f}_{{𝒟}^{′}}^{*} ( x ) \text{=:} {\hat{y}}_{x}$$

$$if and only if {ℙ}_{{𝒟}^{′}} [ {y}_{x} \vert x ] < {ℙ}_{{𝒟}^{′}} [ {\hat{y}}_{x} \vert x ] ,$$

but the margin condition guarantees that [symbol] [yₓ|x]− [symbol] [ŷₓ|x]≥γ, thus,

$${ℙ}_{x ∼ 𝒟} [ {f}_{𝒟}^{*} ( x ) \neq {f}_{{𝒟}^{′}}^{*} ( x ) ] \leq {ℙ}_{x ∼ {𝒟}_{χ}} [ \vert {ℙ}_{𝒟} [ {y}_{x} \vert x ] - {ℙ}_{{𝒟}^{′}} [ {y}_{x} \vert x ] \vert > γ \leq \leq {𝔼}_{x ∼ 𝒟} [ \vert {ℙ}_{𝒟} [ {y}_{x} \vert x ] - {ℙ}_{{𝒟}^{′}} [ {y}_{x} \vert x ] \vert ] / γ .$$

Where we use Markov inequality for the second transition. Now, we can use the alternative definition of TV to conclude the proof (here p (x) is the Radon-Nikodym measure of x under the marginal [symbol] and [symbol] (x, y) is the Radon-Nikodym measure of (x, y) under [symbol] ):

$${𝔼}_{x ∼ {𝒟}_{χ}} [ \vert {ℙ}_{𝒟} [ {y}_{x} \vert x ] - {ℙ}_{{𝒟}^{′}} [ {y}_{x} \vert x ] \vert ] = \int \vert {ℙ}_{𝒟} [ {y}_{x} \vert x ] - {ℙ}_{{𝒟}^{′}} [ {y}_{x} \vert x ] \vert p ( x ) \leq \leq \frac{1}{2} \int \vert {p}_{𝒟} ( x , y ) - {p}_{{𝒟}^{′}} ( x , y ) \vert \leq ε$$

Where the penultimate inequality is based on an easy corollary of the triangle inequality: ∀y we have

$${\sum }_{y} \vert {ℙ}_{𝒟} [ y \vert x ] - {ℙ}_{{𝒟}^{′}} [ y \vert x ] \vert \geq 2 \vert {ℙ}_{𝒟} [ y \vert x ] - {ℙ}_{{𝒟}^{′}} [ y \vert x ] \vert .$$

We proceed to prove the 2^{rd} property. For each x∈ [symbol] let y₁ and y₂ be the two most likely labels respectively with respect to the distribution [symbol] , that is,

$${y}_{1} ( x ) = arg {max}_{y} {ℙ}_{𝒟} [ y \vert x ] and$$

$${y}_{2} ( x ) = arg {max}_{y \neq {y}_{1} ( x )} {ℙ}_{𝒟} [ y \vert x ] and {y}_{1}^{′} , {y}_{2}^{′}$$

defined similarly for [symbol] . Then, for a given x, if the margin is small, i.e.,

$${ℙ}_{{𝒟}^{′}} [ {y}_{1}^{′} \vert x ] - {ℙ}_{{𝒟}^{′}} [ {y}_{2}^{′} \vert x ] < γ - τ$$

then we will want to prove that the following holds:

$${\sum }_{y} \vert {ℙ}_{𝒟} [ y \vert x ] - {ℙ}_{{𝒟}^{′}} [ y \vert x ] \vert > τ \qquad ( 5 )$$

$$If {y}_{1} \neq {y}_{1}^{′}$$

then with probability 1 we have

$${ℙ}_{𝒟} [ {y}_{1} \vert x ] - {ℙ}_{𝒟} [ {y}_{1}^{′} \vert x ] > γ .$$

Using the definition of

$${y}_{1}^{′} ,$$

$${ℙ}_{𝒟} [ y \vert x ] - {ℙ}_{𝒟} [ {y}_{1}^{′} \vert x ] + {ℙ}_{{𝒟}^{′}} [ {y}_{1}^{′} \vert x ] - {ℙ}_{{𝒟}^{′}} [ y \vert x ] > γ > τ$$

If, on the other hand,

$${y}_{1} = {y}_{1}^{′}$$

using [symbol] [y₁|x]− [symbol] [y₂|x]>γ again we have (by summing up the inequalities):

$${ℙ}_{{𝒟}^{′}} [ {y}_{1}^{′} \vert x ] - {ℙ}_{{𝒟}^{′}} [ {y}_{2}^{′} \vert x ] + {ℙ}_{{𝒟}^{′}} [ {y}_{2}^{′} \vert x ] - {ℙ}_{{𝒟}^{′}} [ {y}_{1}^{′} \vert x ] > τ$$

So in both cases Equation 5 holds. Thus,

$${ℙ}_{x} [ {ℙ}_{{𝒟}^{′}} [ {y}_{1}^{′} ( x ) \vert x ] - {ℙ}_{{𝒟}^{′}} [ {y}_{2}^{′} ( x ) \vert x ] < γ - τ ] \leq {ℙ}_{x} [ {\sum }_{y} \vert {ℙ}_{𝒟} [ y \vert x ] - {ℙ}_{{𝒟}^{′}} [ y \vert x ] \vert > τ ] \leq {𝔼}_{x} [ {\sum }_{y} \vert {ℙ}_{𝒟} [ y \vert x ] - {ℙ}_{{𝒟}^{′}} [ y \vert x ] \vert ] / τ = 2 TV ( 𝒟 , {𝒟}^{′} ) / τ = 2 \frac{ε}{τ}$$

### Proof of Theorem 9.

$$Fix ε ∈ ( 0 , 1 ) and 0 < τ < γ ( 𝒟 ) . Let m = m ( \frac{ε ( 1 - γ ( 𝒟 ) + τ )}{2} ) .$$

Fix some x∈ [symbol] such that

$${f}_{𝒟}^{*} ( x ) \neq ( x ) = arg {max}_{y} [ y \vert x ] Then , {ℙ}_{S ∼ {𝒟}^{m}} [ ( S ) ( x ) \neq {f}_{𝒟}^{*} ( x ) ] = [ y \neq {f}_{𝒟}^{*} ( x ) \vert x ] \geq \frac{1}{2}$$

Therefore, since [symbol] is a learner with sample complexity m(·) we have:

$$\frac{ε}{2} \geq {𝔼}_{S ∼ {𝒟}^{m}} {L}_{{D}^{*}} ( ( S ) ) = {𝔼}_{x ∼ {𝒟}_{𝓍}} {ℙ}_{S ∼ {𝒟}^{m}} [ ( S ) ( x ) \neq {f}_{𝒟}^{*} ( x ) ] \geq {𝔼}_{x} [ {ℙ}_{S} [ ( S ) ( x ) \neq {f}_{𝒟}^{*} ( x ) ] \vert {f}_{𝒟}^{*} ( x ) \neq ( x ) ] \cdot {ℙ}_{x} [ {f}_{𝒟}^{*} ( x ) ] \neq ( x ) ] \geq \frac{1}{2} {ℙ}_{x} [ {f}_{𝒟}^{*} ( x ) ] \neq ( x ) ] = \frac{1}{2} {L}_{{𝒟}^{*}} ( )$$

So, the first condition of Definition 7 holds. For the second condition, observe the since

$${)}_{}$$

is the Bayes optimal classifier, we have:

$$η ( ( {D}^{m} ) ) = [ y \neq ( x ) ] \leq [ y \neq {f}_{𝒟}^{*} ( x ) ] = {𝔼}_{x ∼ 𝒟} {ℙ}_{S ∼ {𝒟}^{m}} [ ( S ) ( x ) \neq {f}_{𝒟}^{*} ( x ) ] = {𝔼}_{S ∼ {𝒟}^{m}} {L}_{{𝒟}^{*}} ( ( S ) ) \leq \frac{δ ( 1 - γ ( 𝒟 ) + τ )}{2}$$

where the last inequality is using the fact that [symbol] is a learner. From Lemma 19, since

$$η ( ( 𝒟 ) ) \leq \frac{δ ( 1 - γ ( 𝒟 ) + τ )}{2} ,$$

it holds that γ_{δ}( [symbol] ( [symbol] ))≥γ( [symbol] )−τ.

Lemma 19 Let [symbol] be a distribution with μ-bounded noise, i.e., η( [symbol] )= [symbol] [y≠ƒ*(x)]≤μ where ƒ* is the Bayes optimal classifier. Let 0<γ<1 be some positive constant denoting a margin. Then,

$${ℙ}_{x ∼ {𝒟}_{𝓍}} [ {ℙ}_{𝒟} ( {f}_{𝒟}^{*} ( x ) \vert x ) < {max}_{y \neq {f}_{𝒟}^{*} ( x )} {ℙ}_{𝒟} ( y \vert x ) + γ ] \leq \frac{2 \cdot μ}{( 1 - γ )}$$

Proof For each x∈ [symbol] let y₁(x) and y₂(x) be the two most likely labels respectively, that is, y₁(x)=arg max_{y} [symbol] [y|x] and y₂(x)=arg max_{y≠y}_{₁}₍ₓ₎ [symbol] [y|x]. Let γₓ= [symbol] [y₁ (x)|x]− [symbol] [y₂(x)|x] and denote the set of small margin examples B={x|γₓ≤γ}. Then we have,

$$\begin{matrix}η ( 𝒟 ) = {𝔼}_{x} [ ℙ [ Y \neq {y}_{1} ( x ) \vert x ] ] \geq \\ \geq {𝔼}_{x} [ ℙ [ Y \neq {y}_{1} ( x ) \vert x ] \vert x ∈ B ] ℙ [ x ∈ B ] \geq \\ \geq ℙ ( B ) \cdot \frac{1 - γ}{2}\end{matrix}$$

Where the last inequality is proven via the following lemma:

Lemma 20 Given a fixed x∈B s.t. γₓ≤γ (in notation of Lemma 19) for some 0<γ<1. Then,

$$ℙ [ Y \neq {y}_{1} ( x ) \vert x ] \geq \frac{1 - γ}{2}$$

Proof Since the x is fixed we drop all x related notation WLOG:

$$\begin{matrix}ℙ [ Y = {y}_{1} ] = 1 - ℙ [ Y \neq {y}_{1} ] \leq \\ \leq 1 - ℙ [ Y = {y}_{2} ] \leq \\ \leq 1 - ℙ [ Y = {y}_{1} ] + γ\end{matrix}$$

Thus, by rearranging we get

$$ℙ [ Y = {y}_{1} ] \leq \frac{1 + γ}{2} which implies ℙ [ Y \neq {y}_{1} ] \geq \frac{1 - γ}{2}$$

### Appendix B. Proofs of Section 3

To prove Theorem 10 we use the following Lemma:

Lemma 21 Let [symbol] be some learning algorithm. Fix some γ>0 and τ<γ. Then, for every x s.t.

$$[ ( x ) \vert x ] > [ - ( x ) \vert x ] + γ and$$

$$( x ) = {f}_{𝒟}^{*} ( x )$$

it holds that:

$${ℙ}_{{S}_{1} , ... , {S}_{k ∼ {D}^{m}}} [ {f}_{𝒟}^{*} ( x ) \frac{1}{k} {\sum }_{i = 1}^{k} ( {S}_{i} ) ( x ) \leq τ ] \leq exp ( - \frac{{k ( γ - τ )}^{2}}{4} )$$

### Proof of Lemma 21.

Fix some x∈ [symbol] and denote

$${p}_{x} ( y ) = [ y \vert x ] = {ℙ}_{S ∼ {𝒟}^{m}} [ ( S ) ( x ) = y ]$$

$$Let {y}_{x}^{*} = arg {max}_{y} {p}_{x} ( y ) = ( x ) .$$

So, assume that x satisfies the assumption, namely assume that

$${p}_{x} ( {y}_{x}^{*} ) > {p}_{x} ( - {y}_{x}^{*} ) + γ and {y}_{x}^{*} = {f}_{𝒟}^{*} ( x ) .$$

Denote

$${y}_{x}^{( i )} = 𝒜 ( {S}_{i} ) ( x ) ,$$

the prediction of the i-th teacher on x. Then,

$$𝔼 [ \frac{1}{k} {y}_{x}^{*} {\sum }_{i = 1}^{k} {y}_{x}^{( i )} ] = 𝔼 [ {y}_{x}^{*} {y}_{x}^{( 1 )} ] = {p}_{x} ( {y}_{x}^{*} ) - {p}_{x} ( - {y}_{x}^{*} ) > γ$$

By Hoeffding's inequality we get:

$$ℙ [ \frac{1}{k} {y}_{x}^{*} {\sum }_{i = 1}^{k} {y}_{x}^{( i )} \leq τ ] \leq exp ( - \frac{{k ( 𝔼 [ \frac{1}{k} {y}_{x}^{*} {\sum }_{i = 1}^{k} {y}_{x}^{( i )} ] - τ )}^{2}}{4} ) = exp ( - \frac{{k ( γ - τ )}^{2}}{4} )$$

### Proof of Theorem 10

Let [symbol] ⊆ [symbol] be the subset of points x∈ [symbol] satisfying the assumptions of Lemma 21 with

$$γ = \frac{γ ( 𝒟 )}{2} and τ = 0.$$

Observe that, using the union bound, and the properties of the teacher [symbol] :

$${ℙ}_{x ∼ 𝒟} [ x ∉ {𝒳}^{′} ] \leq {ℙ}_{x ∼ 𝒟} [ {ℙ}_{𝒜 ( {𝒟}^{m} )} [ {f}_{A ( {𝒟}^{m} )}^{*} ( x ) \vert x ] > {ℙ}_{𝒜 ( {𝒟}^{m} )} [ - {f}_{𝒜 ( {𝒟}^{m} )}^{*} ( x ) \vert x ] + γ ] + {ℙ}_{x ∼ 𝒟} [ {f}_{𝒜 ( {𝒟}^{m} )}^{*} ( x ) \neq {f}_{𝒟}^{*} ( x ) ] \leq ε / 3 + {L}_{{𝒟}^{*}} ( {f}_{𝒜 ( {𝒟}^{m} )}^{*} ) \leq \frac{2 ε}{3}$$

Now, fix some x∈ [symbol] , and from Lemma 21 we have:

$${𝔼}_{{S}_{1} , … , {S}_{k} ∼ {𝒟}^{m}} 1 \{ {𝒜}_{e n s} ( {S}_{1} , … , {S}_{k} ) ( x ) \neq {f}_{𝒟}^{*} ( x ) \} \leq exp ( - \frac{k {γ}^{2}}{4} ) \leq ε / 3$$

Finally, we get:

$${𝔼}_{{S}_{1} , … , {S}_{k} ∼ {𝒟}^{m}} {L}_{{𝒟}^{*}} ( {𝒜}_{e n s} ( {S}_{1} , … , {S}_{k} ) ) = {𝔼}_{{S}_{1} , … , {S}_{k} ∼ {𝒟}^{m}} {𝔼}_{x} 1 \{ {𝒜}_{e n s} ( {S}_{1} , … , {S}_{k} ) ( x ) \neq {f}_{𝒟}^{*} ( x ) \} = {ℙ}_{x ∼ 𝒟} [ x ∈ {𝒳}^{′} ] {𝔼}_{x \vert x ∈ {𝒳}^{′}} {𝔼}_{{S}_{1} , … , {S}_{k} ∼ {𝒟}^{m}} 1 \{ {𝒜}_{e n s} ( {S}_{1} , … , {S}_{k} ) ( x ) \neq {f}_{𝒟}^{*} ( x ) \} + {ℙ}_{x ∼ D} [ x ∉ {𝒳}^{′} ] \cdot {𝔼}_{x \vert x ∉ {𝒳}^{′}} {𝔼}_{{S}_{1} , … , {S}_{k} ∼ {𝒟}^{m}} 1 \{ {𝒜}_{e n s} ( {S}_{1} , … , {S}_{k} ) ( x ) \neq {f}_{𝒟}^{*} ( x ) \} \leq ( 1 - \frac{2 ε}{3} ) \frac{ε}{3} + \frac{2 ε}{3} \leq ε$$

### Proof of Theorem 11.

Fix a sequence of k subsets of examples [symbol] =(S₁, . . . , Sₖ), and let [symbol] _{S} be the distribution given by sampling x˜ [symbol] and returning (x, y) where y= [symbol] ₑₙₛ (S₁, . . . , Sₖ) (x). Let [symbol] be an i.i.d. sample of size m′ from [symbol] _{S}. Let [symbol] = [symbol] ( [symbol] ). By the Fundamental Theorem of Statistical Learning (e.g. Theorem 6.8 in Shalev-Shwartz and Ben-David (2014)) w.p. at least 1−ε/4 over sampling [symbol] we have:

$${L}_{{\tilde{𝒟}}_{𝒮}} ( {h}_{𝒮} ) \leq {inf}_{h ∈ ℋ} {L}_{{\tilde{𝒟}}_{𝒮}} ( h ) + ε / 4 \leq {L}_{{\tilde{𝒟}}_{𝒮}} ( {f}_{𝒟}^{*} ) + ε / 4 = {ℙ}_{x ∼ 𝒟} [ {𝒜}_{e n s} ( 𝒮 ) ( x ) \neq {f}_{𝒟}^{*} ( x ) ] + ε / 4 = {L}_{{𝒟}^{*}} ( {𝒜}_{e n s} ( 𝒮 ) ) + ε / 4$$

On the other hand, observe that for all h:

$${L}_{{𝒟}^{*}} ( h ) = {𝔼}_{x \sim 𝒟} \{ h ( x ) \neq {f}_{𝒟}^{*} ( x ) \} \leq {𝔼}_{x \sim 𝒟} ( 1 \{ h ( x ) \neq {𝒜}_{e n s} ( 𝒮 ) ( x ) \} + 1 \{ {𝒜}_{e n s} ( 𝒮 ) ( x ) \neq {f}_{𝒟}^{*} ( x ) \} ) = {L}_{{\tilde{𝒟}}_{𝒮}} ( h ) + {L}_{{𝒟}^{*}} ( {𝒜}_{e n s} ( 𝒮 ) )$$

Overall we get that w.p. at least 1−ε/4 over sampling [symbol] we have:

$${L}_{{𝒟}^{*}} ( {h}_{𝒮} ) \leq 2 {L}_{𝒟} * ( {𝒜}_{e n s} ( 𝒮 ) ) + ε / 4$$

$${𝔼}_{{\tilde{𝒮}}_{𝒮} \sim {\tilde{𝒟}}_{𝒮}^{{m}^{′}}} {L}_{{𝒟}^{*}} ( {h}_{𝒮} ) \leq 2 {L}_{{𝒟}^{*}} ( {𝒜}_{e n s} ( 𝒮 ) ) + ε / 2$$

and therefore:

Finally, using Theorem 10 we get:

$${𝔼}_{{S}_{1} , … , {S}_{k} , \tilde{S}} {L}_{{𝒟}^{*}} ( h ) \leq 2 {𝔼}_{{S}_{1} , … , {S}_{k} \sim {𝒟}^{m}} ( {𝒜}_{e n s} ( {S}_{1} , … , {S}_{k} ) ) + ε / 2 \leq ε$$

where h is the output of the Ensemble-Pseudo-Labeling algorithm.

To prove Theorem 12, we use the following Lemma:
Lemma 22 Assume that [symbol] is a teacher for some distribution [symbol] , with sample complexity \tilde{m}. Then, for every ε, δ∈(0, 1), taking

$$m \geq \tilde{m} ( \frac{ε}{3} , \frac{γ ( 𝒟 )}{2} ) and k \geq \frac{64}{{γ ( 𝒟 )}^{2}} log ( \frac{3}{ε δ} )$$

we get that w.p. at least 1−δ over the choice of S₁, . . . , Sₖ, it holds that:

$${ℙ}_{x ∼ D} [ {f}_{𝒟}^{*} ( x ) \frac{1}{k} {\sum }_{i = 1}^{k} 𝒜 ( {S}_{i} ) ( x ) \leq γ ( 𝒟 ) / 4 ] \leq ε$$

Proof of Lemma 22. Let [symbol] ⊆ [symbol] be the subset of points x∈ [symbol] satisfying the assumptions of Lemma 21 with

$$γ = \frac{γ ( 𝒟 )}{2} and τ = \frac{γ ( 𝒟 )}{4} .$$

Observe that, using the union bound, and the properties of the teacher [symbol] :

$${ℙ}_{x ∼ 𝒟} [ x ∉ {𝒳}^{′} ] \leq {ℙ}_{x ∼ 𝒟} [ {ℙ}_{𝒜 ( {𝒟}^{m} )} [ {f}_{A ( {𝒟}^{m} )}^{*} ( x ) \vert x ] > {ℙ}_{𝒜 ( {𝒟}^{m} )} [ - {f}_{𝒜 ( {𝒟}^{m} )}^{*} ( x ) \vert x ] + γ ] + {ℙ}_{x ∼ 𝒟} [ {f}_{𝒜 ( {𝒟}^{m} )}^{*} ( x ) \neq {f}_{𝒟}^{*} ( x ) ] \leq ε / 3 + {L}_{{𝒟}^{*}} ( {f}_{𝒜 ( {𝒟}^{m} )}^{*} ) \leq \frac{2 ε}{3}$$

Let

$${δ}^{′} = \frac{εδ}{3} .$$

Fix some x∈ [symbol] , and from Lemma 21 we have:

$${𝔼}_{{S}_{1} , … , {S}_{k} \sim {𝒟}^{m}} 1 \{ {f}_{𝒟}^{*} ( x ) \frac{1}{k} {\sum }_{i} {ens}_{} ( {S}_{i} ) ( x ) \leq τ \} \leq exp ( - \frac{{k ( γ - τ )}^{2}}{4} ) \leq {δ}^{′}$$

Therefore, we get:

$${𝔼}_{{S}_{1} , … , {S}_{k} \sim {𝒟}^{m}} {ℙ}_{x \sim 𝒟} [ {f}_{𝒟}^{*} ( x ) \frac{1}{k} {\sum }_{i} {ens}_{} ( {S}_{i} ) ( x ) \leq τ \vert x ∈ {𝒳}^{′} ] = {𝔼}_{x} [ {𝔼}_{{S}_{1} , … , {S}_{k} \sim {𝒟}^{m}} 1 \{ {f}_{𝒟}^{*} ( x ) \frac{1}{k} {\sum }_{i} {ens}_{} ( {S}_{i} ) ( x ) \leq τ \} \vert x ∈ {𝒳}^{′} ] \leq {δ}^{′}$$

Using Markov's inequality we get that w.p. at least

$$1 - \frac{3 {δ}^{′}}{ε} we have {ℙ}_{x \sim 𝒟} [ {f}_{𝒟}^{*} ( x ) \frac{1}{k} {\sum }_{i} {ens}_{} ( {S}_{i} ) ( x ) \leq τ \vert x ∈ {𝒳}^{′} ] \leq \frac{ε}{3}$$

and in this case we have

$${ℙ}_{x \sim 𝒟} [ {f}_{𝒟}^{*} ( x ) \frac{1}{k} {\sum }_{i} {ens}_{} ( {S}_{i} ) ( x ) \leq τ ] \leq {ℙ}_{x \sim 𝒟} [ {f}_{𝒟}^{*} ( x ) \frac{1}{k} {\sum }_{i} {ens}_{} ( {S}_{i} ) ( x ) \leq τ \vert x ∈ {𝒳}^{′} ] + {ℙ}_{x \sim 𝒟} [ x ∈ {𝒳}^{′} ] \leq ε$$

Proof of Theorem 12. Fix ε>0 and let

$${ε}^{′} = \frac{γ ( 𝒟 ) ε}{18} .$$

Fix a sequence of k subsets of examples [symbol] =(S₁, . . . , Sₖ), and let [symbol] be the distribution over [symbol] ×y given by sampling x˜ [symbol] , sampling i˜{1, . . . , k} and returning (x, y) where y= [symbol] (Sᵢ)(x). Let [symbol] be an i.i.d. sample of size m′ from [symbol] . Let [symbol] = [symbol] ( [symbol] ). By the Fundamental Theorem of Statistical Learning (e.g. Theorem 6.8 in Shalev-Shwartz and Ben-David (2014)) w.p. at least 1−ε′ over sampling [symbol] we have:

$$\begin{matrix}{L}_{{\tilde{D}}_{𝒮}} ( {h}_{𝒮} ) \leq {L}_{{\tilde{D}}_{𝒮}} ( h ) + {ε}^{′} \leq {L}_{{\tilde{D}}_{𝒮}} ( {f}_{𝒟}^{*} ) + {ε}^{′} \\ = \begin{matrix}{𝔼}_{x \sim 𝒟} [ 1 \{ {f}_{𝒟}^{*} ( x ) \neq y \} ] \leq {𝔼}_{x \sim 𝒟} [ 1 \{ {f}_{𝒟}^{*} ( x ) \neq \\ {ens}_{} ( 𝒮 ) ( x ) \} + 1 \{ {ens}_{} ( 𝒮 ) ( x ) \neq y \} ] + {ε}^{′}\end{matrix} \\ = {L}_{{𝒟}^{*}} ( {ens}_{} ( 𝒮 ) ) + {L}_{{\tilde{D}}_{S}} ( {ens}_{} ( 𝒮 ) ) + {ε}^{′}\end{matrix}$$

Claim: If S satisfies γ_{ε′}( [symbol] )>0 then w.p. at least 1−ε′ over the choice of

$${\tilde{S}}_{𝒮} \sim {\tilde{𝒟}}_{𝒮}^{m ′}$$

$${L}_{{𝒟}^{*}} ( {h}_{𝒮} ) \leq ( {L}_{{𝒟}^{*}} ( {ens}_{} ( 𝒮 ) ) + {ε}^{′} ) ( 1 + {{γ}_{{ε}^{′}} ( {\tilde{𝒟}}_{𝒮} )}^{- 1} )$$

Proof: W.p. at least 1−ε′ we have [symbol] ( [symbol] )≤ [symbol] ( [symbol] ₑₙₛ( [symbol] ))+L_{D*}( [symbol] ₑₙₛ( [symbol] ))+ε′. Notice that by definition of [symbol] , we have that [symbol] ₑₙₛ( [symbol] ) is the Bayes optimal classifier for [symbol] . Therefore, by

Lemma 3 we have

$${L}_{{\tilde{D}}_{𝒮}^{*}} ( {h}_{𝒮} ) \leq + {ε}^{′} .$$

Now, we have:

$$\begin{matrix}{L}_{{𝒟}^{*}} ( {h}_{𝒮} ) = {𝔼}_{x \sim 𝒟} [ 1 \{ {h}_{𝒮} ( x ) \neq {f}_{𝒟}^{*} ( x ) \} ] \\ \leq {𝔼}_{x \sim 𝒟} [ 1 \{ {h}_{𝒮} ( x ) \neq {ens}_{} ( 𝒮 ) ( x ) + 1 {ens}_{} ( 𝒮 ) ( x ) \neq {f}_{𝒟}^{*} ( x ) \} ] \\ = \begin{matrix}{L}_{{\tilde{𝒟}}_{𝒮}^{*}} ( {h}_{𝒮} ) + {L}_{{𝒟}^{*}} ( {ens}_{} ( 𝒮 ) ) \leq \\ \frac{{ε}^{′} + {L}_{{𝒟}^{*}} ( {ens}_{} ( 𝒮 ) )}{{γ}_{{ε}^{′}} ( {\tilde{𝒟}}_{𝒮} )} + {ε}^{′} + {L}_{{𝒟}^{*}} ( {ens}_{} ( 𝒮 ) )\end{matrix}\end{matrix}$$

Claim: W.p.>1−ε′ over the choice of [symbol] , we have

$${γ}_{{ε}^{′}} ( {\tilde{𝒟}}_{𝒮} ) \geq \frac{γ ( 𝒟 )}{4}$$

and [symbol] ( [symbol] ₑₙₛ( [symbol] ))≤ε′. Proof: By Lemma 22, since

$$m \geq \tilde{m} ( \frac{{ε}^{′}}{3} , \frac{γ ( 𝒟 )}{2} , \frac{{ε}^{′}}{3} ) and k \geq \frac{64}{{γ ( 𝒟 )}^{2}} log ( \frac{3}{{( {ε}^{′} )}^{2}} )$$

we have, w.p.>1−ε′ over the choice of S, that

$${ℙ}_{x \sim 𝒟} [ ( {ℙ}_{i \sim [ k ]} [ ( {S}_{i} ) ( x ) = {f}_{𝒟}^{*} ( x ) \vert x ] - {ℙ}_{i \sim [ k ]} [ ( {S}_{i} ) ( x ) = - {f}_{𝒟}^{*} ( x ) \vert x ] ) > γ ( 𝒟 ) / 4 ] = {ℙ}_{x \sim 𝒟} [ {f}_{𝒟}^{*} ( x ) \frac{1}{k} {\sum }_{i} ( {S}_{i} ) ( x ) > γ ( 𝒟 ) / 4 ] \leq {ε}^{′}$$

which immediately implies the required.

From the above two claims, w.p. at least 1−2ε′ over the choice of [symbol] , [symbol] we have

$${L}_{{D}^{*}} ( {h}_{𝒮} ) \leq 2 {ε}^{′} ( 1 + {{γ}_{{ε}^{′}} ( {\tilde{D}}_{𝒮} )}^{- 1} ) \leq \frac{16 {ε}^{′}}{γ ( 𝒟 )}$$

$$and therefore {𝔼}_{𝒮 , {\tilde{S}}_{𝒮}} {L}_{{𝒟}^{*}} ( {h}_{𝒮} ) \leq \frac{16 {ε}^{′}}{γ ( 𝒟 )} + 2 {ε}^{′} \leq \frac{18 {ε}^{′}}{γ ( 𝒟 )} = ε .$$

### Appendix C. Proofs of Section 4

Using standard measure-theoretic arguments, we show that for any distribution [symbol] , such a cover exists:

Lemma 23 For a every distribution [symbol] over [symbol] × [symbol] there exists a function m_{c}:(0, 1)×(0, 1)→ [symbol] s.t. for every, ε, δ∈(0, 1) there exists a subset [symbol] ⊆ [symbol] satisfying:

$${ℙ}_{x ∼ {𝒟}_{𝒳}} [ x ∉ {𝒳}^{′} ] \leq δ$$

If m≥m_{c}(ε, δ), for all x∈ [symbol] it holds that

$${ℙ}_{S ∼ {𝒟}_{𝓍}^{m}} [ d ( x , S ) > ε ] \leq δ .$$

Proof of Lemma 23 Fix some ε, δ∈(0, 1) and let δ′=δ/2, ε′=ε/2. For some x₀∈ [symbol] and let Bᵣ(x₀) be the closed ball of radius r around x₀, i.e.

$${B}_{r} ( {x}_{0} ) = \{ x ∈ \text{𝒳:} d ( {x}_{0} , x ) \leq r \}$$

Now, for some x₀∈ [symbol] , observe that

$$𝒳 = {⋃}_{r = 1}^{∞} {B}_{r} ( {x}_{0} ) ,$$

and therefore we have:

$$1 = {𝒟}_{𝓍} ( 𝒳 ) = {𝒟}_{𝓍} ( {⋃}_{r = 1}^{∞} {B}_{r} ( {x}_{0} ) ) = {lim}_{r \to ∞} {𝒟}_{𝓍} ( {B}_{r} ( {x}_{0} ) )$$

So, there exists some r s.t. [symbol] (Bᵣ(x₀))≥1−δ′. Now, since Bᵣ(x₀) is closed and bounded in (X, d), from the Heine-Borel property we get that Bᵣ(x₀) is also compact. Since Bᵣ(x₀)⊆U_{x∈B}_{ᵣ}₍ₓ_{₀}₎ B_{ε′}(x), there exists some finite subset C⊆Bᵣ(x₀) such that Bᵣ(x₀)⊆U_{x∈C}B_{ε′}(x). Now, let C′∈C be the subset of balls that have at least δ′/|C| mass under [symbol] , namely:

$${C}^{′} = \{ x ∈ {C \text{:𝒟}}_{𝓍} ( {B}_{{ε}^{′}} ( x ) ) \geq \frac{{δ}^{′}}{\vert C \vert} \}$$

$$Let m = ⌈ \frac{\vert C \vert}{{δ}^{′}} log ( \frac{\vert C \vert}{{δ}^{′}} ) ⌉ ,$$

and observe that for every x∈C′ we have:

$${ℙ}_{S ∼ {𝒟}_{𝓍}^{m}} [ S ⋂ {B}_{{ε}^{′}} ( x ) = ∅ ] = {{ℙ}_{{x}^{′} ∼ {𝒟}_{𝓍}} [ {x}^{′} ∉ {B}_{{ε}^{′}} ( x ) ]}^{m} \leq {( 1 - \frac{{δ}^{′}}{\vert C \vert} )}^{m} \leq exp ( - \frac{{m δ}^{′}}{\vert C \vert} ) \leq \frac{{δ}^{′}}{\vert C \vert}$$

Using the union bound, w.p. at least 1−δ′ it holds that for all x∈C′ the exists x′∈S s.t. x′∈B_{ε′}(x). Denote by [symbol] all the points in [symbol] that are covered by C″, namely [symbol] =U_{x∈C′}B_{ε′}(x).

Claim: [symbol] \ [symbol] ⊆( [symbol] \Bᵣ(x₀)∪(∪_{x∈C\C′}B_{ε′}(x)

Proof: Let x∈ [symbol] \ [symbol] and we need to show x∈( [symbol] \Bᵣ(x₀)∪(∪_{x∈C\C′}B_{ε′}(x). If x∉Bᵣ(x₀) we are done. Otherwise, if x∈Bᵣ(x₀), since Bᵣ(x₀)⊆∪_{x′∈C}B_{ε′}(x) there exists some x′∈C s.t. x∈B_{ε′}(x′), and x′∉C′ since otherwise we would have x∈ [symbol] .

Claim: [symbol] [x∉ [symbol] ]≤2δ′

Proof: Using the union bound and the previous result:

$${ℙ}_{x ∼ {𝒟}_{𝓍}} [ x ∉ {𝒳}^{′} ] \leq {ℙ}_{x ∼ {𝒟}_{𝓍}} [ x ∉ {B}_{r} ( {x}_{0} ) ] + {\sum }_{{x}^{′} ∈ C ∖ {C}^{′}} {ℙ}_{x ∼ {𝒟}_{𝓍}} [ x ∈ {B}_{{ε}^{′}} ( {x}^{′} ) ] \leq {δ}^{′} + \vert C \backslash {C}^{′} \vert \frac{{δ}^{′}}{\vert C \vert} \leq 2 {δ}^{′}$$

Claim: W.p. at least 1−δ′ over the choice of

$$S \sim {𝒟}_{χ}^{m} ,$$

for all x∈ [symbol] is holds that d(x,S)≤ε.

Proof: From what we showed, w.p. at least 1−δ′, for all x∈C′ there exits x′∈S s.t. x′∈B_{ε′} (x). Assume this holds, and let x∈ [symbol] . By definition of [symbol] there exists some \hat{x}∈C′ s.t. d(x, \hat{x})≤ε′. So, there is some x′∈S s.t. d(x′, \hat{x})≤ε′, and therefore d(x, x′)≤2ε′=ε and we get the required.

Now, the required follows from the last two claims.

### Proof of Theorem 13.

Let [symbol] be some λ-Lipschitz distribution. Let m_{c}(·,·) be a function satisfying the conditions guaranteed by Lemma 23 for the distribution [symbol] . Then, we prove that the [symbol] _{1-NN} is a sampler for [symbol] , with distributional sample complexity

$$\tilde{m} ( ε ) = {m}_{c} ( \frac{ε}{2 λ} , \frac{ε}{12} ) .$$

Fix ε∈(0, 1) and let

$${ε}^{′} = \frac{ε}{2 λ} , {δ}^{′} = \frac{ε}{12} .$$

Let m_{c} be the function guaranteed by Lemma 23, and let [symbol] be the subset guaranteed by the same Theorem (given the choice of ε′, δ′). Fix some x∈ [symbol] . Denote q:= [symbol] [d(x, S)≤ε′] (the probability to get a good cover). By Lemma 23, for m=m_{c}(ε′, δ′) we get that q≥1−δ′. For every y∈y, denote pₓ(y): = [symbol] [y|x], and we have:

$$\vert {ℙ}_{S ∼ {𝒟}^{m}} [ {NN}_{} ( S ) ( x ) = y ] - {p}_{x} ( y ) \vert \leq q \vert {ℙ}_{S ∼ {𝒟}^{m}} [ {NN}_{} ( S ) ( x ) = y \vert d ( x , S ) \leq ε ] - {p}_{x} ( y ) \vert + ( 1 - q ) \vert {ℙ}_{S ∼ {𝒟}^{m}} [ {NN}_{} ( S ) ( x ) = y \vert d ( x , S ) > ε ] - {p}_{x} ( y ) \vert \leq \vert {ℙ}_{𝒟} [ y \vert π ( x , S ) , d ( x , S ) \leq ε ] - {p}_{x} ( y ) \vert + 2 {δ}^{′} \leq λ {ε}^{′} + 2 {δ}^{′}$$

From the above we get:

$${𝔼}_{x} {\sum }_{y} \vert {ℙ}_{S ∼ {𝒟}^{m}} [ {NN}_{} ( S ) ( x ) \vert x ] - ℙ [ y \vert x ] \vert \leq {𝔼}_{x \vert x ∈ {𝒳}^{′}} {\sum }_{y} \vert {ℙ}_{S ∼ {𝒟}^{m}} [ {NN}_{} ( S ) ( x ) \vert x ] - ℙ [ y \vert x ] \vert + 2 \vert 𝓎 \vert {ℙ}_{x ∼ 𝒟} [ x ∉ 𝒳 ] \leq λ {ε}^{′} + 6 {δ}^{′} \leq ε$$

and therefore the required follows.

### Proof of Theorem 14

Let [symbol] be some λ-Lipschitz distribution. Let m_{c}(·, ·) be a function satisfying the conditions guaranteed by Lemma 23 for the distribution [symbol] . Then, we prove that the [symbol] _{k-NN} algorithm is a teacher for [symbol] , with sample complexity

$$\tilde{m} ( ε , τ ) = k \cdot {m}_{c} ( \frac{τ}{4 λ} , min \{ ε , \frac{τ}{4 k} \} ) .$$

Fix ε∈(0,1), τ∈(0, γ( [symbol] )) and let

$${ε}^{′} = \frac{τ}{4 λ} , {δ}^{′} = min \{ ε , \frac{τ}{4 k} \} .$$

Let m_{c} be the function guaranteed by Lemma 23, and let [symbol] be the subset guaranteed by the same Theorem (given the choice of ε′, δ′). Fix some x∈ [symbol] . Let S be the set of subsets of [symbol] such that [symbol] ∈ [symbol] if and only if for all x′∈k−π(x, [symbol] ) it holds that d(x, x′)≤ε′. Let m=k·m_{c}(ε′, δ′).

Claim: [symbol] [ [symbol] ∈ [symbol] ]≥1−kδ′

Proof: For every set S⊆ [symbol] ×y of size m, split S to blocks of k examples S⁽¹⁾, . . . , S^{(k)} each of size m_{c}(ε′, δ′). By Lemma 23, for every i it holds that

$${ℙ}_{{S}^{( i )} ∼ {𝒟}^{m / k}} [ d ( x , {S}_{𝒳}^{( i )} ) > {ε}^{′} ] \leq {δ}^{′} .$$

Using the union bound, with probability at least 1−kδ′ if holds that for every i∈[k] we have

$$d ( x , {S}_{𝒳}^{( i )} ) \leq {ε}^{′} ,$$

in which case there are at least k examples in S with distance ≤ε′ to x, so [symbol] ∈ [symbol] .

$$Clai \text{m:} {ℙ}_{S ∼ {𝒟}^{m}} [ {k - NN}_{} ( S ) ( x ) = {f}_{𝒟}^{*} ( x ) \vert {S}_{𝓍} ∈ 𝒮 ] \geq \frac{1}{2} + \frac{γ ( 𝒟 )}{2} - \frac{τ}{4}$$

Proof: Fix some [symbol] ∈ [symbol] , and w.l.o.g. assume that k−π(x, [symbol] )={x₁, x₂, . . . , xₖ}. Then,

$${ℙ}_{{S}^{′} ∼ {𝒟}^{m}} [ {k - NN}_{} ( S ) ( x ) = {f}_{𝒟}^{*} ( x ) \vert {S}_{𝓍}^{′} = {S}_{𝓍} ] = {ℙ}_{{S}^{′} ∼ {𝒟}^{m}} [ sign ( {\sum }_{i = 1}^{k} {y}_{i} ) = {f}_{𝒟}^{*} ( x ) \vert {S}_{𝓍}^{′} = {S}_{𝓍} ]$$

$$Denote {p}_{i} = {ℙ}_{{S}^{′} ∼ {𝒟}^{m}} [ {y}_{i} = {f}_{𝒟}^{*} ( x ) \vert {S}_{𝓍}^{′} = {S}_{𝓍} ] = {ℙ}_{𝒟} [ {f}_{𝒟}^{*} ( x ) \vert {x}_{i} ] .$$

Now, observe that:

$${p}_{i} \geq {ℙ}_{𝒟} [ {f}_{𝒟}^{*} ( x ) \vert x ] - λ d ( x , {x}_{i} ) \geq {ℙ}_{𝒟} [ {f}^{*} ( x ) \vert x ] - λ {ε}^{′} \geq \frac{1}{2} + \frac{γ ( 𝒟 )}{2} - λ {ε}^{′} \geq \frac{1}{2} + \frac{γ ( 𝒟 )}{2} - \frac{τ}{4}$$

where the first inequality uses the λ-Lipschitz property of [symbol] , and the third inequality is by definition of γ( [symbol] ). Now, from the Conodorcet Jury Theorem in Ben-Yashar and Paroush (2000), it holds that:

$${ℙ}_{{S}^{′} ∼ {𝒟}^{m}} [ sign ( {\sum }_{i = 1}^{k} {y}_{i} ) = {f}_{𝒟}^{*} ( x ) \vert {S}_{𝓍}^{′} = {S}_{𝓍} ] \geq \frac{1}{k} {\sum }_{i = 1}^{k} {p}_{i} \geq \frac{1}{2} + \frac{γ ( 𝒟 )}{2} - \frac{τ}{4}$$

and the claim follows from the law of total probability.

Claim: For every x∈ [symbol] it holds that

$${ℙ}_{S ∼ {𝒟}^{m}} [ {k - NN}_{} ( S ) ( x ) = {f}_{𝒟}^{*} ( x ) ] \geq \frac{1}{2} + \frac{γ ( 𝒟 ) - τ}{2} .$$

Proof: Observe that, using the previous claims:

$${ℙ}_{S ∼ {𝒟}^{m}} [ {k - NN}_{} ( S ) ( x ) \neq {f}_{𝒟}^{*} ( x ) ] \leq {ℙ}_{S ∼ {𝒟}^{m}} [ {k - NN}_{} ( S ) ( x ) \neq {f}_{𝒟}^{*} ( x ) \vert {S}_{𝓍} ∈ 𝒮 ] + {ℙ}_{S ∼ {𝒟}^{m}} [ S ∉ 𝒮 ] < \frac{1}{2} - \frac{γ ( 𝒟 )}{2} + \frac{τ}{4} + {k δ}^{′} \leq \frac{1}{2} - \frac{γ ( 𝒟 ) - τ}{2}$$

By the previous claim, it follows that for all x∈ [symbol] we have

$$( x ) = {f}_{𝒟}^{*} ( x ) ,$$

and using the fact that [symbol] [x∉ [symbol] ]≤δ′≤ε the first condition for teacher holds. Since we also have [symbol] [x∉ [symbol] ]≤δ′≤δ, by the previous claim we get that γδ( [symbol] _{k-NN}( [symbol] ^{m})≥γ( [symbol] )−τ, and the second condition in the definition of teacher holds.

### Proof of Theorem 15.

Let ε>0 and let ε′=ε/4. We begin with the following claim:

Claim: There exist numbers a<b such that [symbol] [x≤a]= [symbol] [x≥b]=ε′.

Proof: By assumption the function F(a)= [symbol] [x≤a] is continuous and lim_{a→∞}=1, lim_{a→-∞}=0 thus by the intermediate value theorem we have there exist a, b such that F(a)= [symbol] [x≤a]=ε′ and F(b)= [symbol] [x≤b]=1−ε′.

Assume we sample S˜ [symbol] ^{m}, and sort it s.t. S=((x₁, y₁), . . . , (xₘ, yₘ)) where x₁<x₂< . . . <xₘ.

Claim: Fix δ′>0, and assume that

$$m \geq \frac{log ( 2 / {δ}^{′} )}{{ε}^{′}} .$$

Then, w.p. at least 1−δ′ over the choice of S, it holds that

$${ℙ}_{x \sim 𝒟} [ x ∉ [ {x}_{1} , {x}_{m} ] ] \leq 2 {ε}^{′}$$

Proof: Let a, b be the numbers guaranteed by the previous claim. Then, we have

$${ℙ}_{S \sim {𝒟}^{m}} [ {x}_{1} > a ] = {ℙ}_{S \sim {𝒟}^{m}} [ ∀ ( x , y ) ∈ S , x > a ] = {( 1 - {ε}^{′} )}^{m} \leq {e}^{- {ε}^{′} m} \leq \frac{{δ}^{′}}{2}$$

and similarly we get

$${ℙ}_{S \sim {𝒟}^{m}} [ {x}_{m} < b ] \leq \frac{{δ}^{′}}{2} .$$

So, from the union bound, w.p. at least 1−δ′ it holds that x₁≤a and xₘ≥b. In this case, we have:

$${ℙ}_{x \sim 𝒟} [ x ∉ [ {x}_{1} , {x}_{m} ] ] \leq {ℙ}_{x \sim 𝒟} [ x ∉ ( a , b ) ] = 2 {ε}^{′} = ε / 2$$

Claim: Split

$$[ a , b ] to \frac{b - a}{δ}$$

intervals of equal size of δ and denote the intervals by Aᵢ=[a+iδ, a+(i+1)δ). Then, letting

$$m \geq \frac{6 ( b - a )}{εδ} log ( 6 ( b - a ) / εδ ) where δ = ε / 12 λ .$$

$$ℙ [ ∃ {A}_{i} s . t . x ∈ {A}_{i} and ∀ {x}_{j} ∈ S , {x}_{j} ∉ {A}_{i} ] \leq ε / 3.$$

Proof: Denote the above event by B. Now, let pᵢ= [symbol] [x∈Aᵢ], by the union bound:

$$ℙ ( B ) \leq \sum ℙ [ x ∈ {A}_{i} , ∀ {x}_{j} , {x}_{j} ∉ {A}_{i} ] = {\sum }_{i} {{p}_{i} ( 1 - {p}_{i} )}^{m} \leq {\sum }_{i} {p}_{i} {e}^{- {p}_{i} m} = {\sum }_{i : {p}_{i} < \frac{δ}{b - a} ε / 6} {p}_{i} {e}^{- {p}_{i} m} + {\sum }_{i : {p}_{i} > \frac{δ}{b - a} ε / 6} {p}_{i} {e}^{- {p}_{i} m} \leq ε / 6 + {\sum }_{i : {p}_{i} \geq \frac{δ}{b - a} ε / 6} {e}^{- {p}_{i} m}$$

Now, since we chose

$$m \geq \frac{6 ( b - a )}{εδ} log ( 6 ( b - a ) / εδ )$$

we have that,

$$P ( B ) \leq ε / 3.$$

Claim: When m defined as above, we have that,

$${𝔼}_{x} [ {\sum }_{y} \vert {ℙ}_{S \sim {𝒟}^{m}} [ 𝒜 ( S ) ( x ) \vert x ] - ℙ [ y \vert x ] \vert \vert x ∈ [ a , b ] ] \leq ε / 2$$

Proof Let C be the event x∈[a, b] intersected with B^{c}=Ω\B. Then, denote by xᵢ the nearest neighbor of x in S and assume WLOG x∈[xᵢ, xᵢ₊₁]. Conditioned on C, x−xᵢ<δ, thus,

$$\vert {h}_{\hat{θ}} ( x ) - {y}_{i} \vert = \vert \frac{{y}_{i + 1} - {y}_{i}}{{x}_{i + 1} - {x}_{i}} ( x - {x}_{i} ) \vert \leq \frac{\vert {y}_{i + 1} - {y}_{i} \vert}{2} \leq 1$$

And consequently, the sign of x will be yᵢ. Thus, (conditioning on C)

$$\vert {ℙ}_{S ∼ {𝒟}^{m}} [ ( S ) ( x ) \vert x ] - ℙ [ y \vert x ] \vert \leq \vert {ℙ}_{S ∼ {𝒟}^{m}} [ ( S ) ( x ) \vert x ] - ℙ [ y \vert {x}_{i} ] \vert + \vert ℙ [ y \vert {x}_{i} ] - ℙ [ y \vert x ] \vert \leq λ δ \leq ε / 12$$

We thus can conclude that,

$${𝔼}_{x} [ {\sum }_{y} \vert {ℙ}_{S ∼ {𝒟}^{m}} [ ( S ) ( x ) \vert x ] - ℙ [ y \vert x ] ‖ x ∈ [ a , b ] ] \leq ℙ ( B ) + {𝔼}_{x} [ {\sum }_{y} \vert {ℙ}_{S ∼ {𝒟}^{m}} [ ( S ) ( x ) \vert x ] - ℙ [ y \vert x ] ‖ C ] = ε / 2$$

Now combining all of the above conclude the proof of the Theorem.

Proof of Theorem 16. First, we show that [symbol] = [symbol] is a teacher when

$$m = \frac{2 k log ( 2 k / ε )}{ε} . Let S = {\{ ( {x}_{i} , {y}_{i} ) \}}_{i = 1}^{m} ∼ {𝒟}^{m}$$

be the sample set. Also, let

$$B = \{ x ∈ χ \text{\vert ℙ} ( {x}_{i} = x ) \leq \frac{ε}{2 k} \} and G = χ \backslash B .$$

We first show that for every x∈G we have

$$ℙ [ x ∉ S ] \leq \frac{ε}{2 k} .$$

$$ℙ [ x ∉ S \vert x ∈ G ] \leq {( 1 - ε / 2 k )}^{m} \leq {e}^{- log ( 2 k / ε )} = ε / 2 k$$

Now we can use the union bound to show that,

$$ℙ [ ∃ {x}_{i} ∈ G ∖ S ] \leq ε / 2$$

Using the union bound again, we can see that for a new example x′:

$$ℙ [ {x}^{′} ∈ B ] \leq \frac{ε}{2} .$$

Thus, [symbol] [x′∈B or ∃xᵢ∈G\S]≤ε. Now, for each x∈S∩G the label y(x) given by ERM can be seen as a Condorcet Jury voting by the set of {yᵢ|xᵢ=x}. We can use Theorem 1 from Berend and Sapir (2005) that shows that Condorcet Jury voting is monotone in the number of votes. Thus,

$$ℙ [ {f}_{𝒟}^{*} ( {x}^{′} ) = ( {x}^{′} ) ] = 1$$

using the aforementioned conditioning. Similarly, we have that γ_{ε}( [symbol] ( [symbol] ^{m})≥γ( [symbol] ) (i.e., τ=0). As we can condition as before and the CJT monotonicity Theorem implies that the margin can only increase (as the probability of the top label increases).

Lemma 24 Let y₁, . . . , yₙ be some independent random variables with yᵢ∈{±1} s.t. [symbol] (yᵢ=1)=pᵢ, where either p₁, . . . , pₙ∈(1/2, 1] or p₁, . . . , pₙ∈[0, 1/2), and let γ=minᵢ|2pᵢ−1|. Denote

$${y}^{*} = sign ( {Σ}_{i = 1}^{n} {y}_{i} ) , and let ℓ ( y ) = 2 \cdot {Σ}_{i = 1}^{n} 1 \{ {y}_{i} \neq {y}^{*} \} and \tilde{ℓ} ( y , r ) = n ( 1 - r ) for some 0 < r \leq \frac{γ}{3} .$$

Then, there exists some universal constant c>0, s.t. for every δ∈(0, 1), if

$$n \geq \frac{8 log ( 1 / δ )}{{γ}^{2}} w . p .$$

at least 1−δ we have [symbol] (y)< [symbol] (y).

Proof Let

$$S = {\sum }_{i = 1}^{n} {y}_{i} . Observe that :$$

$$ℓ ( y ) = 2 {\sum }_{i = 1}^{n} 1 \{ {y}_{i} \neq {y}^{*} \} = 2 \cdot {\sum }_{i = 1}^{n} ( \frac{1}{2} - \frac{{y}_{i} {y}^{*}}{2} ) = n - {y}^{*} {\sum }_{i = 1}^{n} {y}_{i} = n - \vert S \vert$$

Also note that

$$𝔼 [ S ] = {\sum }_{i = 1}^{n} ( 2 {p}_{i} - 1 ) so \vert 𝔼 [ S ] \vert \geq n γ .$$

Now, from Hoeffding's inequality:

$$ℙ ( \vert S - 𝔼 [ S ] \vert \geq \frac{n γ}{2} ) \leq 2 exp ( - n {γ}^{2} / 8 ) \leq δ$$

So, w.p. at least 1−δ we have:

$$ℓ ( y ) = n - \vert S \vert \leq n - \vert 𝔼 [ S ] \vert + \vert S - 𝔼 [ S ] \vert \leq n - \frac{n γ}{2} < n - rn = \tilde{ℓ} ( y )$$

where we use the fact that

$$r \leq \frac{γ}{3} < \frac{γ}{2} .$$

### Proof of Theorem 18.

Claim. The Bayes optimal classifier ƒ* on [symbol] is constant on each ball.

Proof. Let x∈B(cᵢ, r) and let y₁=:ƒ*(cᵢ) be the arg max [symbol] [y|cᵢ]. Using the margin condition on cᵢ we know that [symbol] (y₁|cᵢ)> [symbol] (y₂|cᵢ)+γ (here y₂=−γ₁). Since x∈ [symbol] (cᵢ) we know that d(x, cᵢ)<r and using the λ-Lipschitzness of the distribution we get that,

$$ℙ ( {y}_{1} \vert x ) \geq ℙ ( {y}_{1} \vert {c}_{i} ) - λ r > ℙ ( {y}_{2} \vert {c}_{i} ) + γ - λ r \geq ℙ ( {y}_{2} \vert x ) + γ - 2 λ r \geq ℙ ( {y}_{2} \vert x )$$

So ƒ*(x)=ƒ*(cᵢ) thus ƒ* on B(cᵢ, r) is determined by ƒ*(cᵢ) and therefore constant on the ball. In a similar fashion, we proceed to show that with high probability a hypothesis output by

is constant on each ball with significant probability mass.

Claim. Let h∈ [symbol] be some function that is not constant on B(cᵢ, r). Then |ĥ(x)|≤2Lr for every x∈B(cᵢ, r).

$$Proof . Fix x ∈ B ( {c}_{i} , r ) and let {x}^{′} ∈ B ( {c}_{i} , r ) s . t . sign \hat{h} ( x ) \neq sign \hat{h} ( {x}^{′} ) . Observe that \vert \hat{h} ( x ) - \hat{h} ( {x}^{′} ) \vert \leq L ‖ x - {x}^{′} ‖ \leq 2 Lr . So , if \hat{h} ( x ) > 0 we get that \hat{h} ( x ) \leq \hat{h} ( x ) - \hat{h} ( {x}^{′} ) \leq 2 Lr$$

otherwise if ĥ(x)≤0 we get that

$$- \hat{h} ( x ) \leq \hat{h} ( {x}^{′} ) - \hat{h} ( x ) \leq 2 Lr$$

Claim. For each ball B(cᵢ, r) with

$$ℙ [ x ∈ B ( {c}_{i} , r ) ] \geq ε / 2 k , if m \geq \frac{16 k log ( 2 k / ε )}{{γ}^{2} ε}$$

we have w.p. at least

$$1 - ε / 2 k that \vert S ⋂ B ( {c}_{i} , r ) \vert \geq n where n = \frac{8 log ( 2 k / ε )}{{γ}^{2}} .$$

Proof. Let

$$S = {\{ ( {x}_{i} , {y}_{i} ) \}}_{i = 1}^{m}$$

and denote ξᵢ=1{xᵢ∈B(cᵢ,r)}, and notice that

$$\vert S ⋂ B ( {c}_{i} , r ) \vert = {Σ}_{i = 1}^{m} {ξ}_{i} . It holds that : 𝔼 [ {Σ}_{i = 1}^{m} {ξ}_{i} ] \geq \frac{m ε}{2 k} .$$

Note, similar to the argument in Theorem 16, if m≥

$$m \geq \frac{2 k log ( 1 / δ )}{ε} w . p . 1 - δ it holds that {Σ}_{i = 1}^{m} {ξ}_{i} \geq \text{} 1. When m \geq \frac{16 k log ( 2 k / ε ) 16 k log ( 2 k / ε ) / {εγ}^{2} )}{{εγ}^{2}}$$

we can apply the same argument for each “block” of size

$$\frac{2 k log ( 16 k log ( 2 k / ε ) / {εγ}^{2} )}{ε} .$$

That is, we are using

$$δ = \frac{{εγ}^{2}}{16 k log ( \frac{2 k}{ε} )}$$

and the number of blocks is

$$n = \frac{8 log ( 2 k / ε )}{{γ}^{2}}$$

to get that with probability

$$1 - δ n = 1 - \frac{ε}{2 k}$$

it holds that

$${\sum }_{i = 1}^{m} {ξ}_{i} \geq \frac{8 log ( 2 k / ε )}{{γ}^{2}} .$$

Claim. For each ball B(cᵢ, r) with [symbol] [x∈B(cᵢ, r)]≥ε/2k the probability that

is constant on B(cᵢ, r) is at least 1−ε/2k.

Proof. From the previous two claims it holds that ƒ* is constant on B(cᵢ, r) and that with probability≥1−ε/2k it holds that |S∩B(cᵢ, r)|≥8 log (2k/ε)/γ². Let n=|S∩B(cᵢ, r)|, and denote (x₁, y₁), . . . , (xₙ, yₙ) the examples in S∩B(cᵢ, r). By definition of γ( [symbol] ) it holds that [symbol] [\tilde{y}ᵢ=1|cᵢ]=pᵢ with |2pᵢ−1|≥γ. Let

$$y *= sign ( {\sum }_{i = 1}^{n} {y}_{i} )$$

and let h*∈ [symbol] be a hypothesis s.t. h*(x)=y*. Let h∈ [symbol] be some function that is not constant on B(cᵢ, r). Then:

$${\sum }_{i = 1}^{n} {ℓ}_{hinge} ( h * ( {x}_{i} ) , {y}_{i} ) = 2 {\sum }_{i = 1}^{n} 1 \{ {y}_{i} \neq y * \} = ℓ ( y )$$

Observe that from the previous claim we have |h(xᵢ)|≤2Lr<1 and therefore:

$${\sum }_{i = 1}^{n} {ℓ}_{hinge} ( h ( {x}_{i} ) , {y}_{i} ) \geq {\sum }_{i = 1}^{n} 1 - {y}_{i} h ( {x}_{i} ) \geq {\sum }_{i = 1}^{n} ( 1 - \vert h ( {x}_{i} ) \vert ) \geq n ( 1 - 2 Lr ) = \tilde{ℓ} ( y , 2 Lr )$$

Therefore, if

$$r \leq \frac{γ}{3 L} ,$$

w.p. at least 1−ε/2 we have

$${\sum }_{i = 1}^{n} {ℓ}_{hinge} ( h * ( {x}_{i} ) , {y}_{i} ) \leq {\sum }_{i = 1}^{n} {ℓ}_{hinge} ( h ( {x}_{i} ) , {y}_{i} )$$

Thus, using the union bound we get that with probability

$$> 1 - ε ,$$

on each ball with probability

$$mass \geq \frac{ε}{2 k}$$

will be constant. Now since the Bayes is fixed on each ball, the output hypothesis could be seen as Condorocet Jury voting on each ball independently thus proving (same argument as Theorem-16) both condition 1 and 2.

### Appendix D. Experimental Details

In this section, we elaborate the exact details used in our experiments. In all experiments, we train ResNet-18 (He et al., 2015) with batch size 128 and 0.0005 weight decay. On CIFAR-10 (Krizhevsky et al., 2009) we train for 50 epochs and for CIFAR-5m we train for 1 epoch using cos-annealing learning rate that starts from 0.05 for both datasets. This optimization procedure achieves ≈94% accuracy on CIFAR-10 when train on clean data. However, we add 20% fixed label noise. With label noise the model (without early stopping) has 81.3% accuracy on the clean test set. For each experiment in the body we use (at-least) 10 random seeds. So for example, for the 10 random teachers experiment we train 100 teacher models and chose 10 fixed teachers at random for each student seed.

1. A non-transitory computer-readable medium having instructions stored thereon that, when executed by processing circuitry, cause the processing circuitry to:
train a set of first machine learning trained-models using a labeled dataset comprising labeled data; and
train a second machine learning trained-model by applying, to each one of a plurality of samples in an unlabeled dataset, a randomly selected one of the set of first machine learning trained-models,
wherein the second machine learning trained-model, upon being deployed as part of a safety system of a vehicle, is used in accordance with received sensor data to enable a vehicle function.

2. The non-transitory computer-readable medium of claim 1, wherein the vehicle comprises an autonomous vehicle (AV), and
wherein the vehicle function comprises object classification.

3. The non-transitory computer-readable medium of claim 1, wherein the training the second machine learning model comprises training the second machine learning model as part of a knowledge distillation process.

4. The non-transitory computer-readable medium of claim 1, wherein the set of first machine learning models produce outputs that replicate a noise distribution of samples in the labeled dataset.

5. The non-transitory computer-readable medium of claim 4, wherein the second machine learning trained-model generates labeled data from the unlabeled dataset having a noise distribution that is less than the noise distribution of samples in the labeled dataset that is replicated by the set of first machine learning models.

6. The non-transitory computer-readable medium of claim 1, wherein the second machine learning model generates labeled data within a predetermined threshold of Bayes class-probabilities generated via a Bayes optimal classifier.

7. The non-transitory computer-readable medium of claim 1, wherein the set of first machine learning models meet a first condition in which a Bayes optimal probability distribution associated with the labeled dataset and a probability distribution of output data generated via the set of first machine learning models are within a first threshold value of one another.

8. The non-transitory computer-readable medium of claim 7, wherein the set of first machine learning models meet a second condition in which a probability mass of a subset of margin samples from the output data generated via the set of first machine learning models is less than a second threshold value.

9. A vehicle, comprising:
a memory configured to store instructions; and
processing circuitry that is part of a safety system of the vehicle, the processing circuitry being configured to execute the instructions stored in the memory to cause the vehicle to:
train a set of first machine learning trained-models using a labeled dataset comprising labeled data; and
train a second machine learning model by applying, to each one of a plurality of samples in an unlabeled dataset, a randomly selected one of the set of first machine learning models,
wherein the second machine learning model, upon being deployed as part of the safety system, is used in accordance with received sensor data to enable a vehicle function.

10. The vehicle of claim 9, wherein the vehicle comprises an autonomous vehicle (AV), and
wherein the vehicle function comprises object classification.

11. The vehicle of claim 9, wherein the processing circuitry is configured to train the second machine learning trained-model as part of a knowledge distillation process.

12. The vehicle of claim 9, wherein the set of first machine learning models produce outputs that replicate a noise distribution of samples in the labeled dataset.

13. The vehicle of claim 12, wherein the second machine learning model generates labeled data from the unlabeled dataset having a noise distribution that is less than the noise distribution of samples in the labeled dataset that is replicated by the first-set of first machine learning models.

14. The vehicle of claim 9, wherein the second machine learning model generates labeled data within a predetermined threshold of Bayes class-probabilities generated via a Bayes optimal classifier.

15. The vehicle of claim 9, wherein the set of first machine learning models meet a first condition in which a Bayes optimal probability distribution associated with the labeled dataset and a probability distribution of output data generated via the set of first machine learning models are within a first threshold value of one another.

16. The vehicle of claim 15, wherein the set of first machine learning models meet a second condition in which a probability mass of a subset of margin samples from the output data generated via the set of first machine learning models is less than a second threshold value.

17. A method, comprising:
training a set of first machine learning trained-models using a labeled dataset comprising labeled data;
training a second machine learning trained-model by applying, to each one of a plurality of samples in an unlabeled dataset, a randomly selected one of the set of first machine learning models;
deploying the second machine learning model to a safety system of a vehicle; and
using the second machine learning model in accordance with received sensor data to enable a vehicle function.

18. The method of claim 17, wherein the vehicle comprises an autonomous vehicle (AV), and
wherein the vehicle function comprises object classification.

19. The method of claim 17, wherein the training the second machine learning model comprises training the second machine learning model as part of a knowledge distillation process.

20. The method of claim 17, wherein the set of first machine learning models produce outputs that replicate a noise distribution of samples in the labeled dataset.

21. The method of claim 20, wherein the second machine learning model generates labeled data from the unlabeled dataset having a noise distribution that is less than the noise distribution of samples in the labeled dataset that is replicated by the set of first machine learning trained-models.

22. The method of claim 17, wherein the second machine learning model generates labeled data within a predetermined threshold of Bayes class-probabilities generated via a Bayes optimal classifier.

23. The method of claim 17, wherein the set of first machine learning models meet a first condition in which a Bayes optimal probability distribution associated with the labeled dataset and a probability distribution of output data generated via the set of first machine learning models are within a first threshold value of one another.

24. The method of claim 23, wherein the set of first machine learning models meet a second condition in which a probability mass of a subset of margin samples from the output data generated via the set of first machine learning trained models is less than a second threshold value.

25. A safety system deployed in a vehicle and being configured to receive sensor data to enable a vehicle function, the safety system comprising:
a storage component configured to store a set of first machine learning models; and
a computing device configured to generate a second machine learning model, which is used in accordance with received sensor data to enable a vehicle function, by:
generating the set of first machine learning models using a labeled dataset comprising labeled data; and
applying, to each one of a plurality of samples in an unlabeled dataset, a randomly selected one of the set of first machine learning models.

26. The safety system of claim 25, wherein the vehicle comprises an autonomous vehicle (AV), and
wherein the vehicle function comprises object classification.

27. The safety system of claim 25, wherein the computing device is configured to train the second machine learning model as part of a knowledge distillation process.

28. The safety system of claim 25, wherein the set of first machine learning models produce outputs that replicate a noise distribution of samples in the labeled dataset.

29. The safety system of claim of claim 28, wherein the second machine learning model generates labeled data from the unlabeled dataset having a noise distribution that is less than the noise distribution of samples in the labeled dataset that is replicated by the set of first machine learning models.

30. The safety system of claim 25, wherein the second machine learning model generates labeled data within a predetermined threshold of Bayes class-probabilities generated via a Bayes optimal classifier.

31. The safety system of claim 25, wherein the set of first machine learning models meet a first condition in which a Bayes optimal probability distribution associated with the labeled dataset and a probability distribution of output data generated via the set of first machine learning models are within a first threshold value of one another.

32. The safety system of claim 31, wherein the set of first machine learning models meet a second condition in which a probability mass of a subset of margin samples from the output data generated via the set of first machine learning models is less than a second threshold value.
